(19) United States
(12) Patent Application Publication
(10) Pub. No.: US 2020/0403809 A1
(43) Pub. Date: Dec. 24, 2020

(54) SERVICE REQUEST AUTHENTICATION UTILIZING PERMISSIONS ASSOCIATED WITH DIGITAL CERTIFICATES

(71) Applicant: eBay Inc., San Jose, CA (US)

(72) Inventors: Michael CHAN, Cupertino, CA (US); Derek CHAMORRO, Austin, TX (US); Venkata Siva Vijayendra BHAMIDIPATI, Milpitas, CA (US); Arpit JAIN, Milpitas, CA (US); Ralph Scott FORSYTHE, Denver, CO (US)

(21) Appl. No.: 16/450,428

(22) Filed: Jun. 24, 2019

(51) Int. Cl. H04L 9/32; H04L 9/06; G06F 16/27

(52) U.S. Cl. CPC H04L 9/3265; H04L 9/0643; H04L 2209/38; G06F 16/27; H04L 9/3236

(57) ABSTRACT

Technologies are shown for authenticating service requests on a communication link established using a digital certificate owned by an entity, where permissions data is associated with the digital certificate. A service request is received from the entity through the communication link. Responsive to the service request, the permissions data associated with the digital certificate is obtained and the service request checked against the permissions data associated with the digital certificate. If the service request is permitted based on the permissions data, the service request is processed. If the service request is not permitted based on the permissions data, the service request is rejected. The permissions data can be stored on a blockchain with a blockchain address in the certificate, in a certificate authority for the certificate, or locally on a server receiving the service request.

### BACKGROUND

Transport Layer Security (TLS) and Secure Sockets Layer (SSL) are cryptographic protocols that can provide security for communications over public Internet Protocol (IP) networks, such as the Internet. The protocols are typically used in applications that communicate data over the Internet, such as applications for web browsing, email, instant message and Voice over IP, to provide privacy and data integrity in communications links between multiple applications.

The identity of the parties in a communication are often authenticated using public-key cryptography based on digital certificates. A digital certificate is issued by a Certification Authority (CA), which is a trusted third party. A certificate contains a public key and the identity of the owner of the key. The certificate is effectively a confirmation by the CA that the public key in the certificate is owned by a subject entity named in the certificate.

In general terms, a certificate is an identity-based material. For example, Domain Validation Certificates validate control over a domain name. Organization Validation Certificates validate that a company is a registered and legally accountable business, and to pass domain validation. Extended Validation certificates enable a green bar display to indicate that the owner's company name and domain is validated on web browsers.

A certificate can contain identity information such as Common name (CN), Locality (L), State (S), Country (C), Organization (O), Organization Unit (OU), Email Address, SAN (Subject Alternative Name), etc. However, none of this data gives any information as to what the services are doing or what its computational server is able to do or access.

However, there is generally no indication for a certificate as to whether the nature of the certificate owner has changed, e.g. a business has changed its operations, or if a computational procedure has been compromised and is no longer operating consistently with the appropriate activity of the certificate owner's business or operations.

It is with respect to these and other considerations that the disclosure made herein is presented.

### SUMMARY

Technologies are disclosed for authentication of a communication link using a digital certificate with associated permissions. To prevent misuse and abuse in connection with a digital certificate, the concessed or allowable operations for a digital certificate are indicated in service permissions associated with the digital certificate. A Certificate Authority or another trusted entity can maintain the permissions for the digital certificate, where the permissions indicate the services or functions that can be accessed based on the certificate. The permissions can be maintained on a blockchain.

Examples of the disclosed technology concern methods, systems and media for authenticating service requests on a communication link that involve receiving a service request from an entity through a communication link established using a digital certificate owned by the entity, where permissions data is associated with the digital certificate and, responsive to the service request, obtaining the permissions data associated with the digital certificate. The service request is checked against the permissions data associated with the digital certificate. If the service request is permitted based on the permissions data, the service request is processed. If the service request is not permitted based on the permissions data, the service request is rejected.

In certain examples, the digital certificate includes a blockchain address to a certificate permissions blockchain that stores the permissions data and the operation of obtaining the permissions data associated with the digital certificate involves obtaining the permissions data from the certificate permissions blockchain using the blockchain address from the digital certificate. Further examples involve receiving modified permissions data for the digital certificate, creating a new permissions data block that stores the modified permissions data, and linking the new permissions data block to a previous permissions data block of the certificate permissions blockchain.

In certain other examples, the permissions data for the digital certificate is stored on a certificate authority for the digital certificate and the operation of obtaining the permissions data associated with the digital certificate involves obtaining the permissions data from the certificate authority for the digital certificate. Further examples involve receiving modified permissions data for the digital certificate and storing the modified permissions data for the digital certificate on the certificate authority for the digital certificate.

In still other examples, the digital certificate includes the permissions data, the permissions data for the digital certificate is stored in a local store, and the operation of obtaining the permissions data associated with the digital certificate involves obtaining the permissions data from the local store.

In particular examples, the operation of obtaining the permissions data associated with the digital certificate involves obtaining the permissions data associated with the digital certificate when authenticating the communication link established using the digital certificate owned by the entity. In other examples, the operation of obtaining the permissions data associated with the digital certificate involves obtaining the permissions data associated with the digital certificate when the service request is received on the communication link established using the digital certificate owned by the entity.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items.

FIG. 1 is an architectural diagram showing an illustrative example of a system for binding service permissions to digital certificates using a blockchain to store certificate permissions data;

FIG. 2 is a data architecture diagram showing an illustrative example of a certificate permissions blockchain with permissions data blocks that secure permissions data for digital certificates;

FIG. 3A is a functional block diagram showing an illustrative example of an architecture for authentication of service requests utilizing service permissions bound to a digital certificate with certificate permissions data stored on a blockchain;

FIG. 3B is a data architecture diagram showing an illustrative example of a digital certificate and data flow for certificate permissions data stored on a blockchain;

FIG. 3C is a functional block diagram showing an illustrative example of an architecture for authentication of service requests utilizing service permissions bound to a digital certificate with certificate permissions data stored on a certificate authority;

FIG. 3D is a data architecture diagram showing an illustrative example of a digital certificate and data flow for certificate permissions data stored on a certificate authority;

FIG. 3E is a functional block diagram showing an illustrative example of an architecture for authentication of service requests utilizing service permissions bound to a digital certificate with certificate permissions data included in metadata in the digital certificate;

FIG. 3F is a data architecture diagram showing an illustrative example of a digital certificate and data flow for certificate permissions data included in metadata in the digital certificate;

FIG. 4A is a control flow diagram showing an illustrative example of a process consistent with the example of FIGS. 3A and 3B for storing certificate permissions data on a certificate permissions blockchain;

FIG. 4B is a control flow diagram showing an illustrative example of a process consistent with the example of FIGS. 3A and 3B for modifying certificate permissions data on a certificate permissions blockchain;

FIG. 4C is a control flow diagram showing an illustrative example of a process consistent with the example of FIGS. 3C and 3D for storing certificate permissions data on a certificate authority;

FIG. 4D is a control flow diagram showing an illustrative example of a process consistent with the example of FIGS. 3E and 3F for including certificate permissions data in metadata in a certificate;

FIG. 4E is a control flow diagram showing an illustrative example of a process in accordance with the disclosed technology for using certificate permissions data to authenticate service requests utilizing service permissions bound to a digital certificate;

FIG. 4F is a control flow diagram showing an illustrative example of a process obtaining certificate permissions data consistent with the example of FIGS. 3A and 3B;

FIG. 4G is a control flow diagram showing an illustrative example of a process obtaining certificate permissions data consistent with the example of FIGS. 3C and 3D;

FIG. 4H is a control flow diagram showing an illustrative example of a process obtaining certificate permissions data consistent with the example of FIGS. 3E and 3F;

FIG. 4I is a control flow diagram illustrating an example of a validation process for blocks added to the permissions data blockchain or certificate permissions data blockchain distributed to untrusted nodes;

FIG. 5 is a data architecture diagram showing an illustrative example of a user using an application programming interface to invoke a method in a data block on the certificate permissions blockchain;

FIG. 6A is a data architecture diagram illustrating a simplified example of a blockchain ledger based on the permissions data blocks of the certificate permissions blockchain of FIG. 1;

FIG. 6B is a data architecture diagram showing an illustrative example of smart contract code, transactions and messages that are bundled into a block so that their integrity is cryptographically secure and so that they may be appended to a blockchain ledger;

FIG. 7 is a computer architecture diagram illustrating an illustrative computer hardware and software architecture for a computing system capable of implementing aspects of the techniques and technologies presented herein;

FIG. 8 is a diagram illustrating a distributed computing environment capable of implementing aspects of the techniques and technologies presented herein; and

FIG. 9 is a computer architecture diagram illustrating a computing device architecture for a computing device capable of implementing aspects of the techniques and technologies presented herein.

### DETAILED DESCRIPTION

In the context of communications security, it can be advantageous to associate permissions with a digital certificate in accordance with the disclosed technology to identity the services or operations that can be accessed or utilized in relation to the digital certificate. The permissions can be maintained by a trusted entity on a blockchain so that the permissions can be widely accessible, transparent and available.

When SSL was first implemented, a digital certificate was generally meant to authenticate for identity trust for web based applications, i.e. the certificate identifies a trusted entity in a communications link. They are usually tied to identifiers (IDs), such as Dedicated IP addresses and Server Name Indication (SNI) extensions. However, SSL does not clearly indicate what the trusted party is allowed to do, i.e. it does not indicate what the trusted party is trusted to do using the certificate. When the applications are trying to access a user's computation resources, such as threads or cookies, knowing that the identity of the user is correct does not assure that the requested access is correct or trusted, especially when the service could have been hijacked to become an attack node.

In general terms, the services are effectively pre-trusted, i.e. the users will use a specific service for a use that is known and previously agreed upon, such as credit card transactions, data transfers, or generally secure communications. However, when a user requests access using a certificate that is trusted by CA signed servers, the certificate can attest to the user's identity, but not the functions or services to which the user should have access. For example, if a business nature has changed, or when the operations are behaving abnormally because of a compromise, the users have no way to know about the change. This also applies when mutual TLS is utilized by users to access the services.

There is also typically no indication as to whether the nature of the business has changed or if the computational procedure has been altered based on the nature of the business or operations. It is also difficult to keep checking if the certificate is still trustworthy as the certificate repository on the CA may be centralized and may not be easily available due to heavy polling from request overload from too many public users. Certificate transparency exists, however, there is no information as to the nature of business or details of computational operation authorized, attested and trusted for the certificate.

The disclosed technology generally relates to an approach to digital identity authentication, such as used in an SSL handshake, that improves security by binding service permissions to a digital certificate. An entity submits a digital certificate during authentication of a communication link that has associated service permissions. Subsequent to authentication, when the entity submits a service request through the communication link, the service request is checked against the service permissions associated with the entity's digital certificate. If the service request is permitted, then the request is processed. If the service request is not permitted, then the request is rejected.

The service permissions for a digital certificate can be stored in a blockchain, where metadata for the digital certificate includes an address on the blockchain for the service permissions. As permissions are revised, a certification authority for the certificate or another trusted entity links a new block to the blockchain to reflect the revised permissions. Alternatively, the service permissions can be identified in the metadata for the digital certificate. When service permissions are revised, a new digital certificate is issued.

An authentication method utilizing service permissions bound to a digital certificate in accordance with the disclosed technology can operate to significantly improve the security of operations associated with the digital certificate.

One technical advantage of certain aspects of the authentication method utilizing service permissions bound to a digital certificate of the disclosed technology is that services or operations accessed utilizing the digital certificate can be limited by the permissions bound to the certificate. Since certain aspects of the disclosed technology provide for the permissions bound to a digital certificate to be modified, security can be improved because the permissions for an entity using a digital certificate can be changed as a business or operation for the entity changes over time.

Another technical advantage of certain aspects of the disclosed technology is that if an entity has been compromised by a malicious actor, a digital certificate utilized by the compromised entity can be limited to accessing the services or operations bound to the certificate, which can limit the use of the compromised entity by the malicious actor.

The identification of a malicious actor can be based on its IP address, or another abstraction. When the disclosed technology is based off a blockchain, a client can be given a corresponding address on the blockchain, which can be used as an identifier associated with the client. The data structures presently utilized for address lookup on blockchains can then be used to identify a client.

Blockchain frameworks can support a very large number of addresses, so this aspect of the disclosed technology can also support a large number of clients. This aspect of the disclosed technology can be particularly advantageous for mobile clients whose identifiers typically will not change over the lifetime of their primary device or an application that may be reinstalled and because of the high volume of mobile client traffic relative to desktop client traffic, which is expected to increase.

The permissions bound to a digital certificate can also be stored on a blockchain and secured by the multi-signature cryptographic and consensus security approaches utilized by the blockchain. Storing permissions for a digital certificate on a blockchain permits the permissions to be widely distributed and accessible and made transparent. Because permissions for digital certificates stored on a blockchain are generally static data stored in multiple distributed copies of the blockchain ledger, the permissions themselves are highly resistant to exploitation

Updates to the permissions can also be stored on the blockchain and the disclosed technology can be configured to obtain the most recent permissions for use in the authorization method. In addition, the updates to the permissions can be audited and traced to their origin.

The permissions in digital certificates can be realized in some implementations by storing the permissions in metadata in the digital certificate itself. When the permissions change, a new digital certificate can be issued with the modified permissions stored in the metadata of the new digital certificate.

In other implementations, the permissions can be maintained in a repository by the CA that issues the digital certificate. The permissions for the digital certificate can be obtained from the CA in a manner similar to the way that digital certificates are validated with the CA. Modifications to the permissions are stored in the repository on the CA.

In general, the authentication method utilizing service permissions bound to a digital certificate of the disclosed technology can prevent a communications link established using a digital certificate from being used to access services or operations that the owner of the digital certificate should not be able to access. Aspects of the disclosed technology provide for permissions for a digital certificate to be modified as the business or operations of the owner of the digital certificate change.

The following Detailed Description describes technologies for authentication utilizing service permissions bound to a digital certificate. The permissions can be maintained on a blockchain for security, accessibility and immutability.

Note that, in some scenarios, different entities can control the permissions. In one example, a Certificate Authority or other trusted entity can be utilized to control modifications or additions to the permissions. In other examples, modifications or additions to the permissions for a digital certificate can require a cryptographic signature of the owner of the digital certificate.

When permissions are stored on a blockchain, the resulting permissions data blocks can provide a record of the permissions defined for a digital certificate and provide a traceable and auditable history of the permissions.

A technical advantage of the disclosed authentication utilizing service permissions bound to a digital certificate includes securely controlling access to services and operations using a digital certificate. A technical advantage of the disclosed authentication technology is its ability to modify the permissions for a digital certificate. Yet another technical advantage of implementations of the disclosed authentication method where the permissions for a digital certificate are stored on a blockchain is the distributed nature of the blockchain, which prevents an unauthorized entity from modifying or corrupting the permissions at any single point. Other technical effects other than those mentioned herein can also be realized from implementation of the technologies disclosed herein.

As will be described in more detail herein, it can be appreciated that implementations of the techniques and technologies described herein may include the use of solid state circuits, digital logic circuits, computer components, and/or software executing on one or more input devices. Signals described herein may include analog and/or digital signals for communicating a changed state of the data file or other information pertaining to the data file.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including multiprocessor systems, mainframe computers, microprocessor-based or programmable consumer electronics, minicomputers, hand-held devices, and the like.

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for authentication utilizing service permissions bound to a digital certificate at a system level will be described. As will be described in more detail below with respect to the figures, there are a number of applications and services that may embody the functionality and techniques described herein.

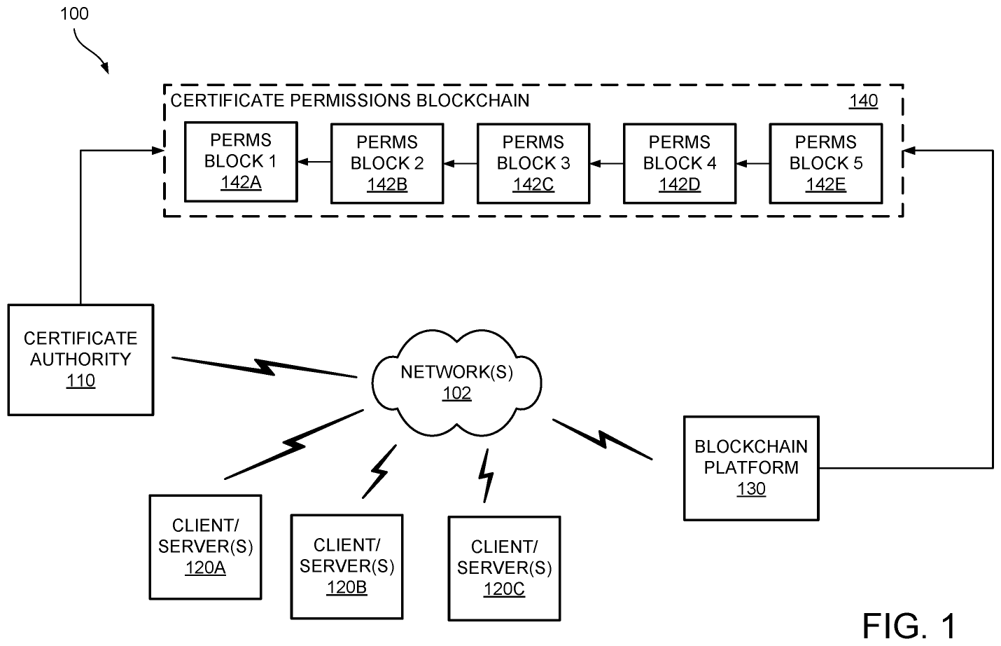

FIG. 1 is an architectural diagram showing an illustrative example of a system architecture 100 wherein a blockchain platform 130 maintains a certificate permissions data blockchain 140 that stores permissions data that binds digital certificates to services or operations and can be accessed via a wide area network 102. In this example, certificate authority 110 stores permissions for certificates in permissions data blocks 142A-E of certificate permissions data blockchain 140. When permissions for a certificate change, a new permissions data block 142 can be created and linked to blockchain 140 to store the modified permissions data. The permissions bound to a certificate can be applied when an entity that owns the certificate makes a request for services, operations or resource access on a communications link that utilizes the certificate.

In the embodiment of FIG. 1, blockchain 140 can be a publicly available blockchain that supports scripting, such as the ETHEREUM blockchain, which supports a SOLIDIFY scripting language, or BITCOIN, which supports a scripting language called SCRIPT. Blockchain 140 can also each be a private blockchain, or a combination of public and private blockchains can be utilized.

In this example, Certificate Authority 110 is a trusted entity that controls the certificate permissions data blockchain 140, where the CA 110 manages certificate permissions for a domain, enterprise or other entity that wishes to apply the disclosed technology for authentication utilizing service permissions bound to a digital certificate to control access to services and operations. The Certificate Authority can add or modify the certificate permissions by adding permissions data blocks 142 to blockchain 140 that add, delete or modify certificate permissions. The permissions data blocks 142 each require the cryptographic signature of the Certificate Authority to be valid.

A Certificate Authority 110, such as one or more servers, or remote computing resources, is controlled by a trusted entity that creates the certificate permissions. The certificate permissions can be established and maintained along with the digital certificates. For example, when an entity establishes its digital certificate, it can provide an initial set of permissions, which the CA 110 maintains.

In the example of FIG. 1, CA 110 initiates a certificate permissions blockchain 140 by creating genesis block 142A when a digital certificate with permissions is created. In other examples, the permissions data blocks 142 can be added to an existing blockchain when certificates are created, or permissions modified. A permissions data block 142 can include methods or function calls that are executed by blockchain platform 130 to obtain access to the permissions data stored for a digital certificate on blockchain 140.

In some embodiments, the Certificate Authority 110 can be replaced by another computing node, such as a computer on a peer-to-peer network, or other computing device controlled by a trusted entity.

In the example of FIG. 1, a permissions data block 142 is generated by CA 110 and the block is secured on permissions data blockchain 140. The permission data stored in permissions data blocks 142 can relate to digital certificates that can be used to establish communications connections between entities, such as client/servers 120A, 120B or 120C, through which services, operations or access to resources can be requested. In this example, the client/servers 120 can communicate with Certificate Authority 110 as well as a network of servers for blockchain platform 130 that supports and maintains blockchain 140. For example, the ETHEREUM blockchain platform from the ETHEREUM FOUNDATION of Switzerland provides a decentralized, distributed computing platform and operating system that provides scripting functionality.

In one example, Certificate Authority 110 owns and controls the permissions data blocks 142 in permissions data blockchain 140. Each permissions data block 142 includes one or more permissions relating to access to services, operations or resources that are allowed or prohibited for an entity associated with a digital certificate for the entity. When certificate permissions are defined, the Certificate Authority 110 creates an permissions data block 142 containing the certificate permissions and links it to certificate permissions blockchain 140. When certificate permissions are added, modified or deleted, a new permissions data block 142 is created that incorporates the changes and the new block 142 is signed by Certificate Authority 110 and linked to the previous permissions data block in the certificate permissions blockchain 140.

Although Certificate Authority 110 maintains control over the certificate permissions, in this example, the certificate permissions blockchain 140 can be made accessible to other entities, such as client/servers 120, so that these entities can obtain, trace or audit the relevant certificate permissions stored in the blocks in the blockchain 140.

In some examples, the certificate permissions blockchain 140 may be viewable to other entities through the use of applications that can access blockchain information. By providing access to the certificate permissions blockchain 140, this approach allows users to readily access certificate permissions maintained on the certificate permissions blockchain 140 under the control of the trusted entity, e.g. the user of Certificate Authority 110.

In another example, aspects of the certificate permissions blockchain 140 may be restricted to being viewable only to entities that are authorized to access the blockchain 140, such as CA 110 or entities that are authenticating a digital certificate or have received an access request over a communications link established using a digital certificate.

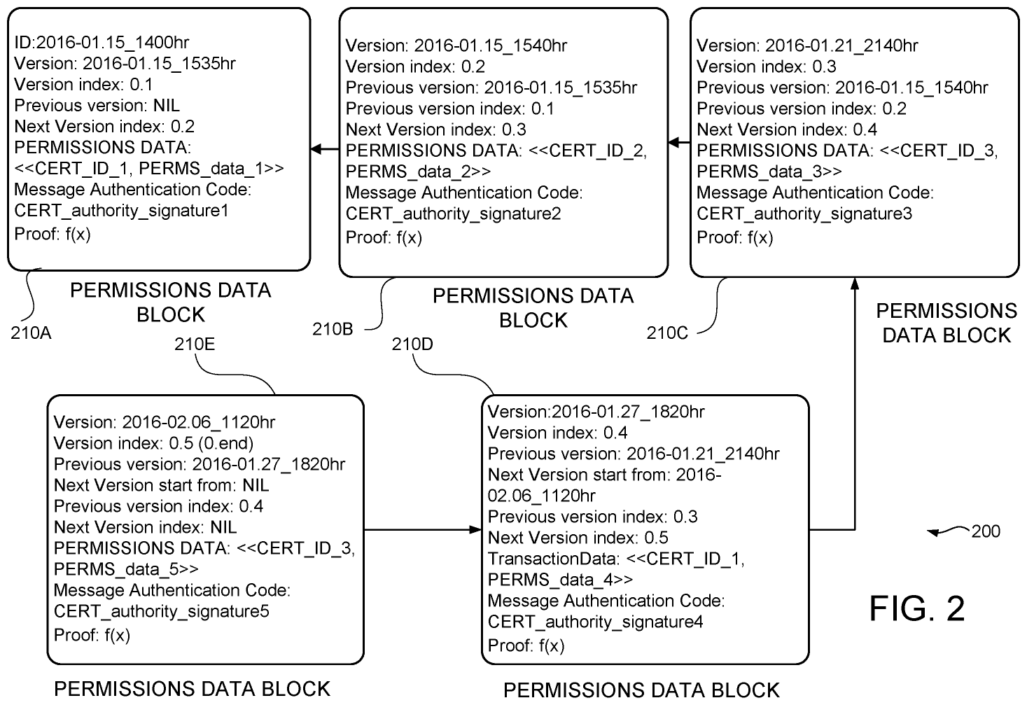

FIG. 2 is a data architecture diagram illustrating a simplified example of a certificate permissions blockchain ledger 200 based on the blocks 142A-E of the certificate permissions blockchain ledger 140 of FIG. 1. The certificate permissions blockchain ledger 200 example of FIG. 2 is simplified to show block headers, metadata and signatures of blocks 210A-E in order to demonstrate storage of certificate permissions data using a blockchain. In outline, a blockchain ledger may be a globally shared transactional database. Signatures can, in some examples, involve all or part of the data stored in the data the blocks 142A-E and can also involve public key addresses corresponding to resource origination entities involved in the creation of resources.

The blockchain ledger 200 may be arranged as a Merkle tree data structure, as a linked list, or as any similar data structure that allows for cryptographic integrity. The blockchain ledger 200 allows for verification that the certificate permissions data has not been corrupted or tampered with because any attempt to tamper will change a Message Authentication Code (or hash) of a block, and other blocks pointing to that block will be out of correspondence. In one embodiment of FIG. 2, each block may point to another block. Each block may include a pointer to the other block, and a hash (or Message Authentication Code function) of the other block.

Each block in the blockchain ledger may optionally contain a proof data field. The proof data field may indicate a reward that is due. The proof may be a proof of work, a proof of stake, a proof of research, or any other data field indicating a reward is due. For example, a proof of work may indicate that computational work was performed. As another example, a proof of stake may indicate that an amount of cryptocurrency has been held for a certain amount of time. For example, if 10 units of cryptocurrency have been held for 10 days, a proof of stake may indicate 10*10=100 time units have accrued. A proof of research may indicate that research has been performed. In one example, a proof of research may indicate that a certain amount of computational work has been performed—such as exploring whether molecules interact a certain way during a computational search for an efficacious drug compound.

The blocks 210 of certificate permissions data blockchain 200 in the example of FIG. 2 shows securing certificate permissions data with a series of permissions data blocks on the blockchain. In this example, CA 110 of FIG. 1 stores permissions data PERMS_data_1 for a first digital certificate identified by CERT_ID_1, e.g. a certificate serial number, in permissions data block 210A. CA 110 signs the permissions data block 210A and the blockchain system within which blockchain 200 is created verifies the permissions data block based on a proof function.

Note that permissions data blocks 210B-E for successive additions, modifications or deletions to certificate permissions can be created and linked to permissions data block 210A such that a history of the certificate permissions is immutably and traceably stored using blockchain 200.

Also note that a variety of approaches may be utilized that remain consistent with the disclosed technology. In some examples relating to certificate permissions, a trusted entity other than the user of Certificate Authority 110, such as system administrators who define certificate permissions, can create, verify or validate permissions data blocks 210A-E. In other examples, multiple entities can be involved in verifying permissions data blocks, such as by requiring signatures from CA 110 and a system administrator who defines certificate permissions, to verify or validate permissions data blocks 210A-E.

In the example of FIG. 2, permissions data blocks 210 of permissions data blockchain 200 include certificate identifiers and permissions data along with a signature of CA 110. To add another permissions data block for the same or a different certificate, CA 110 creates permissions data block 210B, which identifies the certificate CERT_ID_2 and includes the permission data PERMS_data_2. CA 110 signs permissions data block 210B and commits block 210B to blockchain 200 for verification by the blockchain platform. To add a permissions data block for an additional certificate, CA 110 creates permissions data block 210C to secure permission data PERMS_data_3 for certificate CERT_ID_3.

Similarly, to modify permissions data for a certificate, a permissions data block can be created to store the modified permissions data. In the example of FIG. 2, CA 110 creates permissions data block 210D to store modified permissions data PERMS_data_4 for certificate CERT_ID_1. Likewise, to modify the permissions for certificate CERT_ID_3, CA 110 creates permissions data block 210E to store modified permissions data PERMS_data_5.

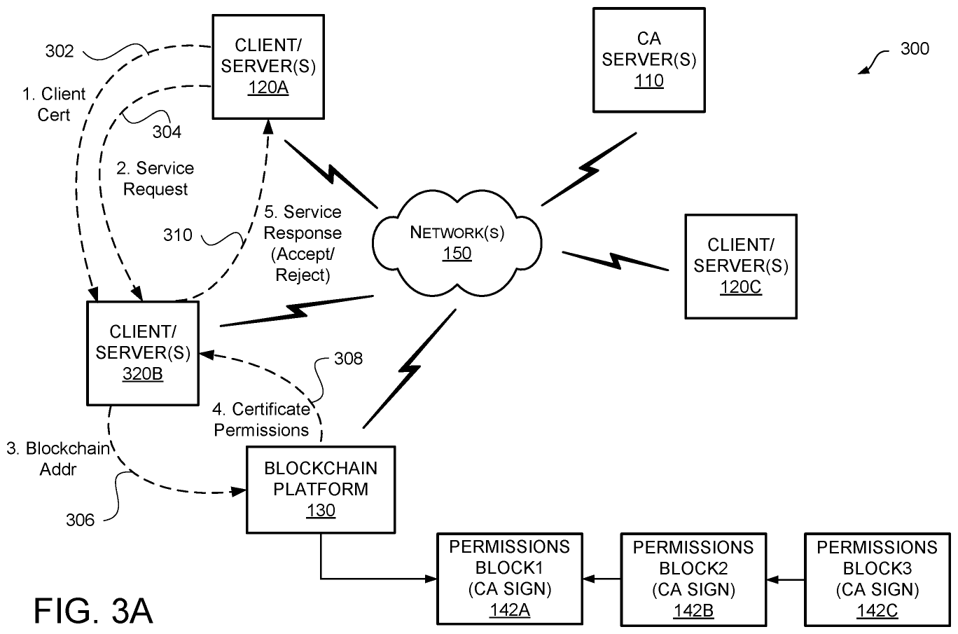

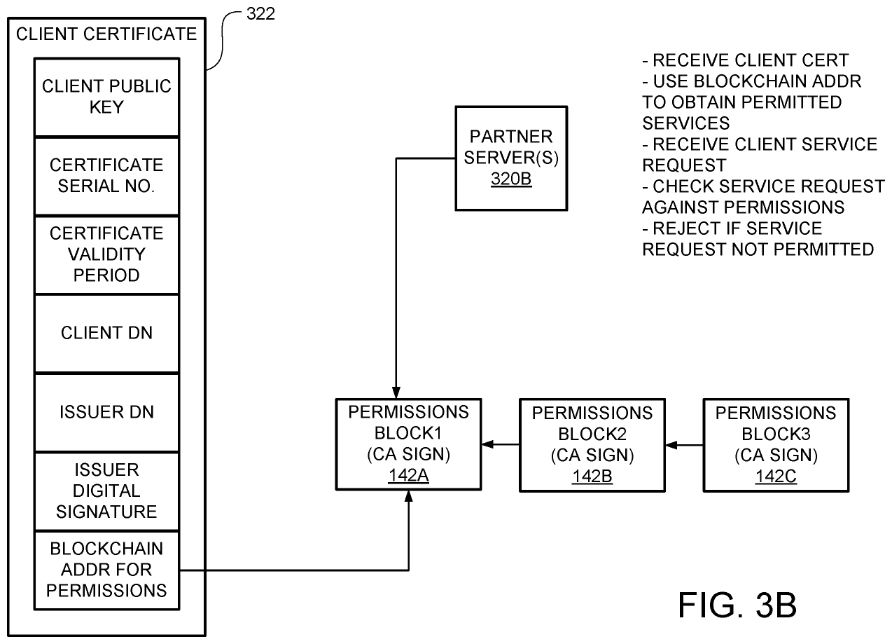

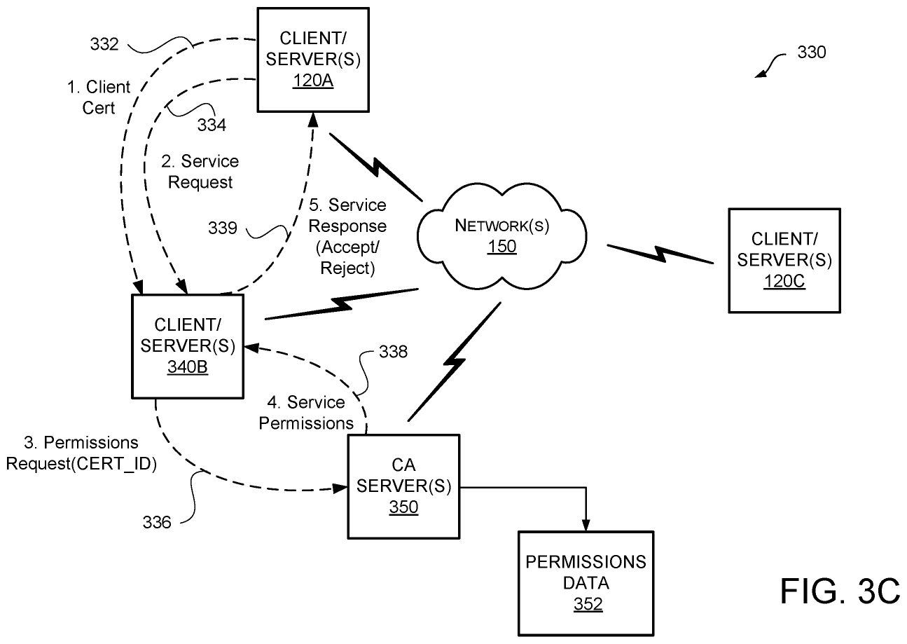

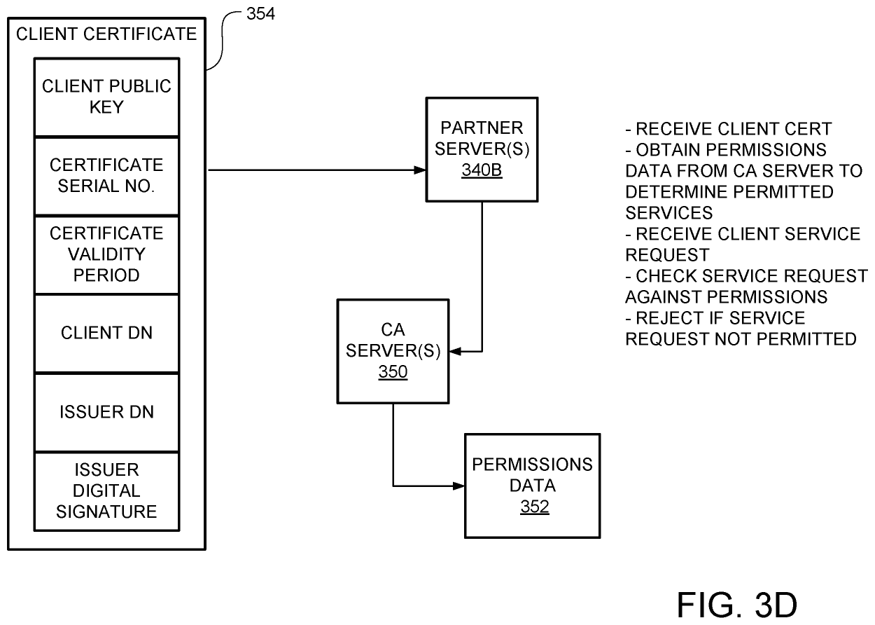

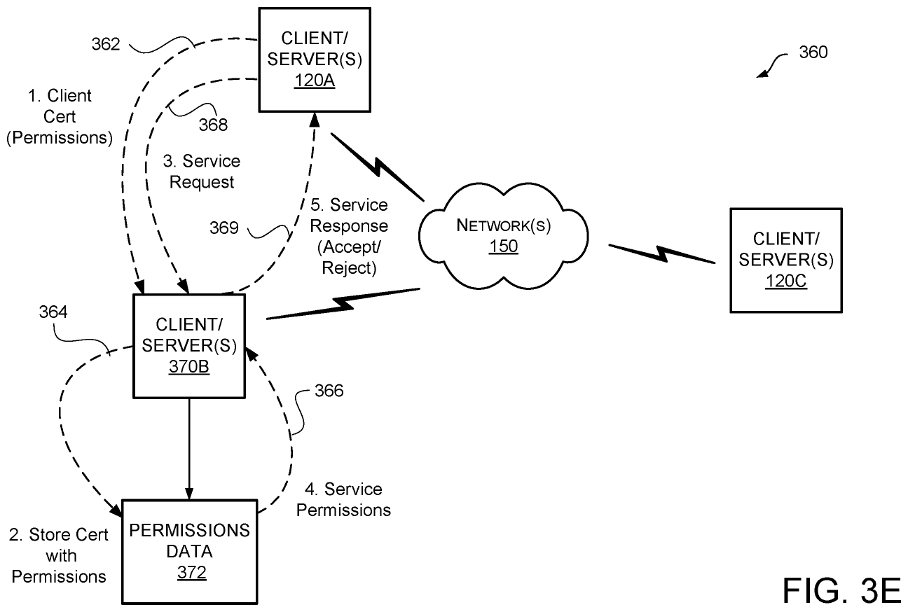

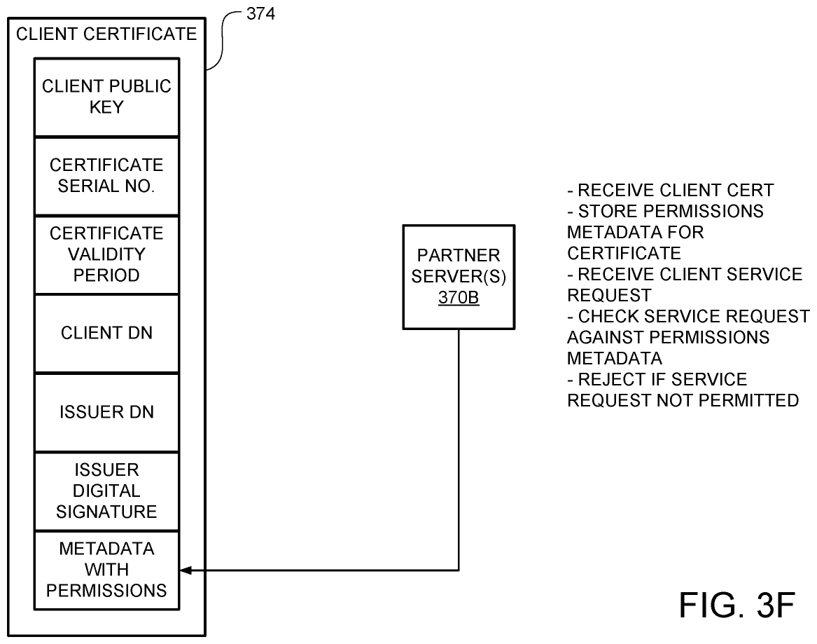

FIG. 3A is a functional block diagram illustrating an example of the authentication utilizing service permissions bound to a digital certificate of the disclosed technology being applied to the service requests from client/server 120A to client server 320B where permissions data is stored in permissions data blocks 142A-C supported by blockchain platform 130.

As noted above, the certificate permissions can be stored in a blockchain and backed by the multisignature cryptographic signature methods currently used by blockchain frameworks to ensure that certificate permissions are secure and trackable to their origins. Modifications of permissions data can be stored in the blockchain by creating and linking additional permissions data blocks 142. When permissions data is obtained from the blockchain, only the latest permissions data is used in the authentication utilizing service permissions bound to a digital certificate of the disclosed technology.

FIG. 3B is a data architecture diagram illustrating an example of a client certificate 322 that includes a blockchain address for a certificate permissions blockchain that stores permissions data for the certificate in permissions data blocks 142A-C. Certificate 322 provided by client 120A, in this example, is similar to a TLS certificate that includes a client public key, a certificate serial number uniquely identifying the digital certificate, a certificate validity period, a client Distinguished Name (DN), an issuer DN, e.g. CA 110, and an issuer digital signature, e.g. the digital signature of CA 110. However, certificate 322 is modified to include a blockchain address for the permissions data stored for the certificate on a certificate permissions blockchain.

In the example of FIGS. 3A and 3B, an entity using client/server 120A, at 302, establishes a communication link with client/server 320B utilizing digital certificate 322. Subsequently, at 304, client/server 120A submits a request for access to a service, function or resource using the communication link established using digital certificate 322. Client/server 320B utilizes the blockchain address from digital certificate 322, e.g. embedded in certificate metadata, to obtain, at 308, current permissions data from the certificate from permissions data blocks 142A-C supported by blockchain platform 130.

Client/server 320B checks the request at 304 against the permissions data for the certificate obtained at 308. If the request is permitted, then client/server 320B accepts and processes the request and returns a response to the request at 310. If the request is not permitted, then the request is rejected at 310.

A technical advantage of the example of FIGS. 3A and 3B is that the permissions data for digital certificate 322 can be modified by adding permissions data blocks to the certificate permissions blockchain. The blockchain address from certificate 322 can remain unchanged. Therefore, the certificate does not need to be replaced or reissued to modify the permissions data for the certificate.

Note that the disclosed technology permits a variety of implementations that remain within the scope of the disclosed technology. For example, the certificate permissions can be obtained by client/server 320B when the communication link is established using the certificate at 302. In another example, the certificate permissions can be obtained by client/server 320B when the service request is received at 304. It will be readily recognized that other variations can be possible with the disclosed technology.

FIG. 3C is a functional block diagram illustrating an example of the authentication utilizing service permissions bound to a digital certificate of the disclosed technology being applied to the service requests from client/server 120A to client server 340B where permissions data for a certificate is stored by Certificate Authority 350. FIG. 3D is a data architecture diagram illustrating an example of a client certificate 354 where CA server 350 has stored permissions data 352 for the certificate.

In the example of FIGS. 3C and 3D, an entity using client/server 120A, at 332, establishes a communication link with client/server 340B utilizing digital certificate 354. Subsequently, at 334, client/server 120A submits a request for access to a service, function or resource using the communication link established using digital certificate 354. Client/server 340B utilizes the certificate serial number CERT_ID from digital certificate 354 to request, at 336, current permissions data 352 for the certificate from CA 350. At 338, CA 350 provides the current permissions data for the certificate to client/server 340B.

Client/server 340B checks the request at 334 against the permissions data for the certificate obtained at 338. If the request is permitted, then client/server 340B accepts and processes the request and returns a response to the request at 339. If the request is not permitted, then the request is rejected at 339.

A technical advantage of the example of FIGS. 3C and 3D is that the digital certificate 354 does not need to be modified from a standard form for a protocol. Instead, the function of client/server 340B and CA server 350 is configured to store, obtain and apply the permissions data maintained for digital certificate 354.

Note that the disclosed technology permits a variety of implementations on this example that remain within the scope of the disclosed technology. For example, the certificate permissions can be obtained by client/server 340B when the communication link is established using the certificate at 332. In another example, the certificate permissions can be obtained by client/server 340B when the service request is received at 334. It will be readily recognized that other variations can be possible with the disclosed technology.

FIG. 3E is a functional block diagram illustrating an example of the authentication utilizing service permissions bound to a digital certificate of the disclosed technology being applied to the service requests from client/server 120A to client server 370B where permissions data for a certificate is stored in metadata included in the digital certificate. FIG. 3F is a data architecture diagram illustrating an example of a client certificate 374 where CA server 350 has embedded permissions data for the certificate within the certificate metadata.

In the example of FIGS. 3E and 3F, an entity using client/server 120A, at 362, establishes a communication link with client/server 370B utilizing digital certificate 374. At 370B, client/server 370B stores the permissions data 372 from certificate 374. Subsequently, at 368, client/server 120A submits a request for access to a service, function or resource using the communication link established using digital certificate 374. Client/server 370B obtains the permission data 372 for the certificate at 366.

Client/server 370B checks the request at 368 against the permissions data for the certificate obtained at 366. If the request is permitted, then client/server 370B accepts and processes the request and returns a response to the request at 369. If the request is not permitted, then the request is rejected at 369.

Note that the permissions data in the examples above can take a variety of forms. For example, the permissions data can take the form of a white list of services, functions or resources that are permitted with the certificate. Other examples can include a black list of services, functions or resources that are not permitted with the certificate. In yet other examples, the permissions data can identify certain users or entities that can be permitted or denied access. Some examples can include a combination of these forms of permissions data.

It will be readily appreciated that the disclosed technology enables complex and sophisticated permissions to be defined for certificates. Many variations can be implemented that differ from the examples illustrated or go beyond the examples illustrated.

The permissions data illustrated above can be defined and determined in a variety of ways. For example, a user with administrative permissions can define the permissions data for a certificate and send the data to the Certificate Authority that issues the certificate. In another example, the Certificate Authority can store permissions data in permissions data blocks on a certificate permissions blockchain that require the signature of both the administrative user and the Certificate Authority.

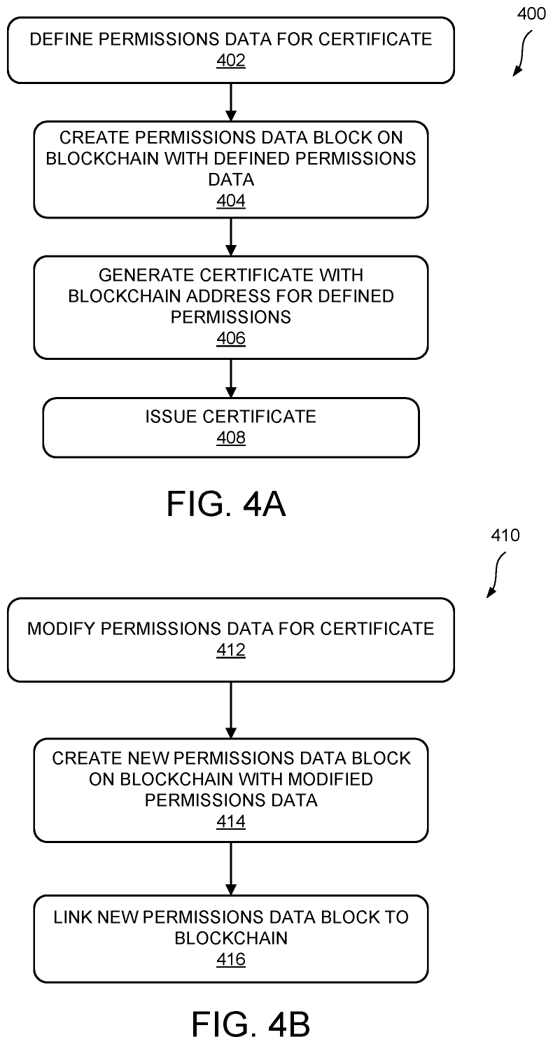

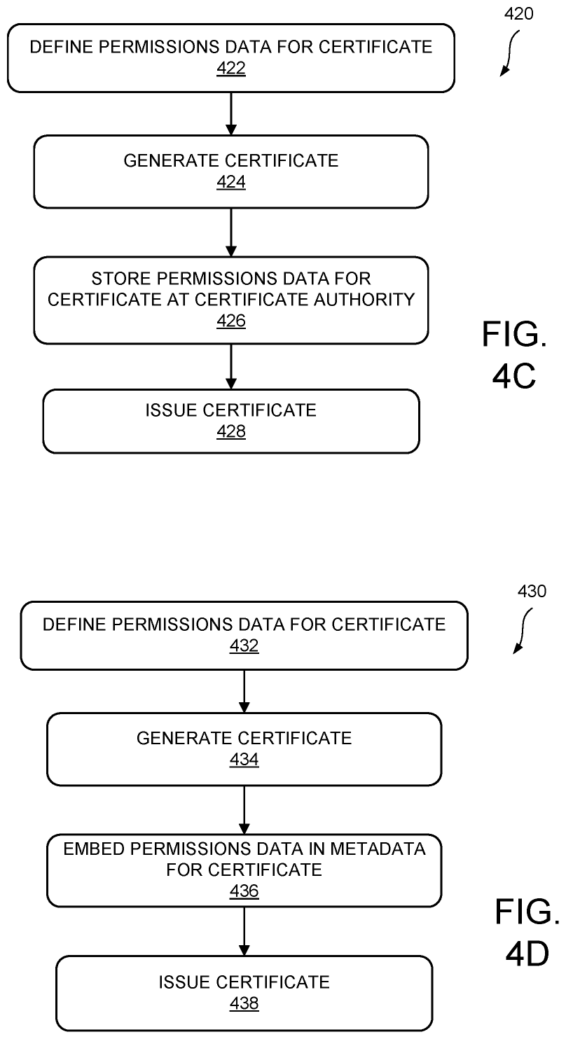

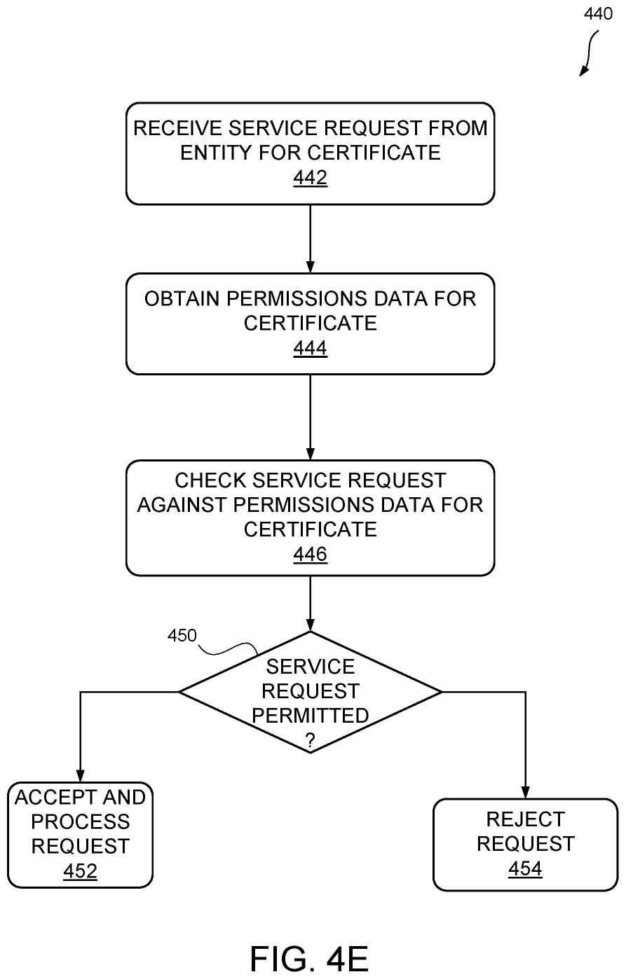

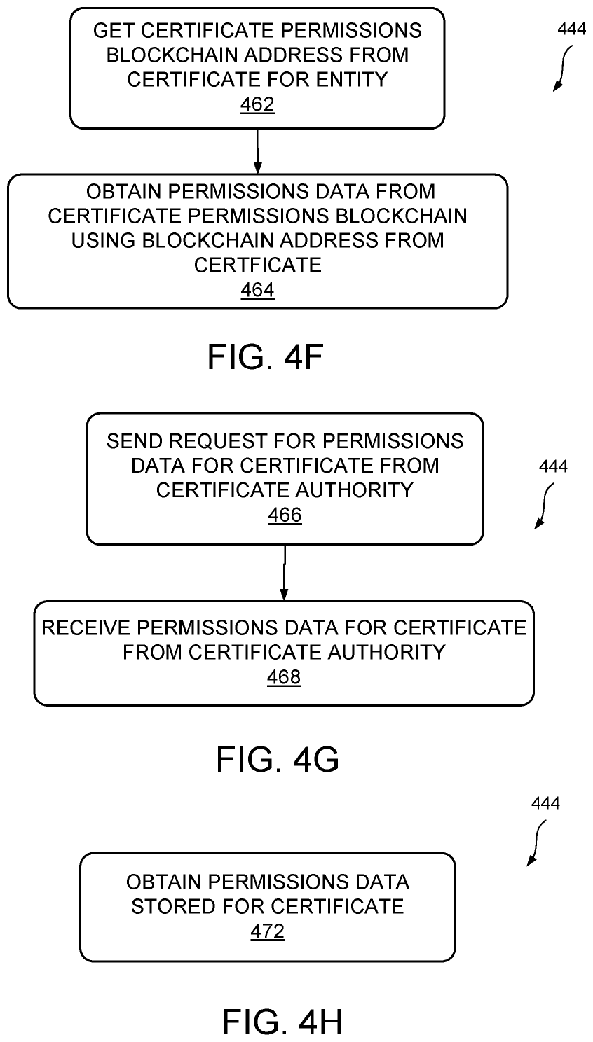

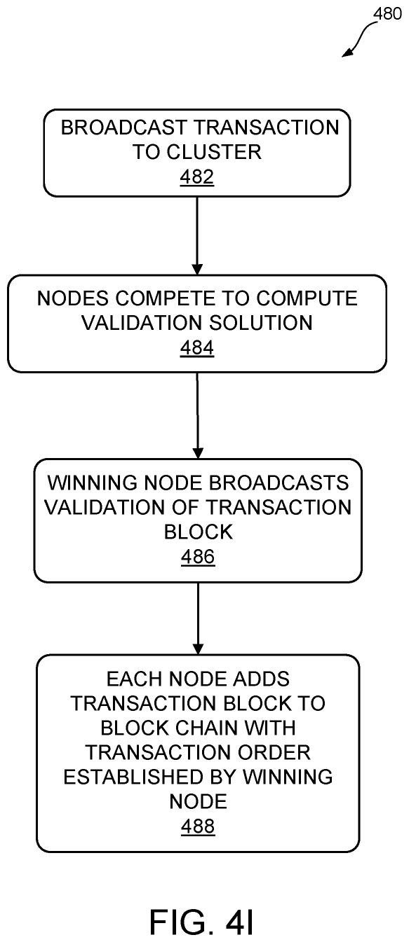

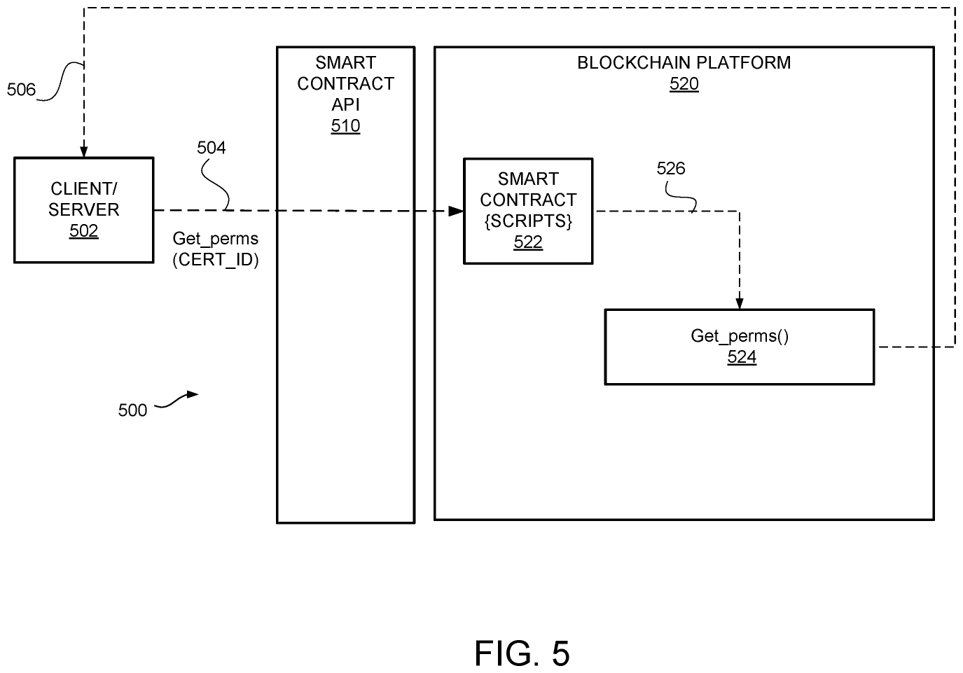

FIG. 4A is a control flow diagram showing an illustrative example of a process 400, such as a process in CA 110 or another trusted entity, that is consistent with the example of FIGS. 3A and 3B. In this example, certificate permissions data is defined and distributed on a certificate permissions blockchain for use in authentication utilizing service permissions bound to a digital certificate in accordance with certain aspects of the disclosed technology.

At 402, permissions data for a certificate are defined or received, such as is described above or in other ways as are suitable for a particular implementation, that can identify services, functions or resources that are permitted or prohibited with the certificate. At 404, a permissions data block is created on a certificate permissions blockchain, as described above, that stores the defined permissions data for the certificate. At 406, the digital certificate is created that includes the blockchain address for the defined permissions data for the certificate. At 408, the certificate is issued for use in establishing a communications link by an entity, e.g. a client identified by a client DN in the certificate.

FIG. 4B is a control flow diagram showing an illustrative example of a process 410, such as a process in CA 110, for modifying the certificate permissions stored on a certificate permissions blockchain by process 400. At 412, modified permissions are defined or received for a certificate. At 414, a new permissions data block is created on the certificate permissions blockchain that stores the modified permissions data. At 416, the new permissions data block with the modified permissions data is linked to the previous permissions data block on the certificate permissions blockchain. As noted above, this approach can provide for the permissions for a certificate to be modified, such as by CA 110 or another trusted entity, through the use of the certificate permissions blockchain indicated by the blockchain address stored in the certificate.

FIG. 4C is a control flow diagram showing an illustrative example of a process 420, such as a process in CA 350 or another trusted entity, that is consistent with the example of FIGS. 3C and 3D. In this example, permissions data for a certificate is defined and stored in the CA or another trusted entity for use in authentication utilizing service permissions bound to a digital certificate in accordance with certain aspects of the disclosed technology.

At 422, permissions data for a certificate are defined or received, such as is described above or in other ways as are suitable for a particular implementation, that can identify services, functions or resources that are permitted or prohibited with the certificate. At 424, the digital certificate is generated to which the permissions data pertains. At 426, the permissions data for the digital certificate is stored at CA 350 for for use in authentication of requests utilizing the certificate. At 428, the certificate is issued for use in establishing a communications link by an entity, e.g. a client identified by a client DN in the certificate.

FIG. 4D is a control flow diagram showing an illustrative example of a process 420, such as a process in a CA or another trusted entity, that is consistent with the example of FIGS. 3E and 3F. In this example, permissions data for a certificate is defined and stored in a digital certificate by a CA that issues the certificate for use in authentication utilizing service permissions bound to a digital certificate in accordance with certain aspects of the disclosed technology.

At 432, permissions data for a certificate are defined or received, such as is described above or in other ways as are suitable for a particular implementation, that can identify services, functions or resources that are permitted or prohibited with the certificate. At 434, the digital certificate is generated to which the permissions data pertains. At 436, the permissions data for the digital certificate is embedded in metadata in the certificate by a CA that issues the certificate for use in authentication of requests utilizing the certificate. At 438, the certificate is issued for use in establishing a communications link by an entity, e.g. a client identified by a client DN in the certificate.

The examples of FIGS. 4A-D illustrate a variety of approaches to distributing certificate permissions data for use in authentication utilizing service permissions bound to a digital certificate in accordance with certain aspects of the disclosed technology. It will be readily understood that other approaches can be utilized in accordance with the disclosed technology.

FIG. 4E is a control flow diagram showing an illustrative example of a process 440 in a server, such as a process in client/server 320B, 340B or 370B, for using certificate permissions data for authentication utilizing service permissions bound to a digital certificate in accordance with certain aspects of the disclosed technology. As discussed above, the certificate permissions bound to a digital certificate process can be configured to control the services, functions or resources that the entity identified in a certificate can access. In addition, implementations of the disclosed technology can be configured for sophisticated control based on the services bound to a digital certificate, such as delaying or accelerating execution of a service request for differential quality of service, dynamic resource allocation or rate limitation purposes.

At 442, a server receives a service request from an entity associated with a digital certificate, e.g. the entity that utilized the digital certificate to establish the communication link over which the service request is received. At 444, the permissions data for the certificate, i.e. the service permissions bound to the digital certificate, is obtained for use in authenticating the service request.

At 446, the service request, e.g. a request for a service, function or resource on the server, is checked against the permissions data for the certificate to determine if the service request is permitted. As noted above, the permissions data can identify the services, functions or resources that the entity using the certificate is permitted or prohibited to access on the server. If the service request is permitted, control branches at 450 to 452 to accept the service request and process it in the normal course of operations, e.g. process the service request and return the results of the processing to the entity that sent the service request. If the service request is not permitted, control branches at 450 to 454 to reject the service request, e.g. return a failure message to entity that sent the serviced request.

FIG. 4F is a control flow diagram illustrating an example of processing at step 444 to obtain the permissions data for the certificate consistent with the example of FIGS. 3A and 3B, wherein permissions data for a certificate is stored on a certificate permissions blockchain. At 462, a blockchain address included in metadata in the certificate used to establish the communications link for the service request from the entity that owns the certificate. At 464, the blockchain address from the certificate is used to obtain the permissions data for the certificate from a certificate permissions blockchain, e.g. the blockchain 140 supported by blockchain platform shown in FIG. 1.

FIG. 4G is a control flow diagram illustrating an example of processing at step 444 to obtain the permissions data for the certificate consistent with the example of FIGS. 3C and 3D, wherein permissions data for a certificate is stored on a Certificate Authority or other trusted entity. At 466, a request for permissions data for a certificate is sent to a Certificate Authority. For example, server 340B sends a request to the CA indicated in the issuer DN of the certificate with the certificate serial number from the certificate. At 468, the permissions data for the certificate is received from the CA. Note that in some examples the request for the permissions data for a certificate can be included in a certificate authentication process with the CA when the communications link is established using the certificate. In other examples, the request for the permissions data from the CA can occur responsive to the service request from the entity using the communications link established using the certificate.

FIG. 4H is a control flow diagram illustrating an example of processing at step 444 to obtain the permissions data for the certificate consistent with the example of FIGS. 3E and 3F, wherein permissions data for a certificate is embedded in metadata in the certificate and stored locally when a communication link is established using the certificate. At 472, the locally stored permissions data for the certificate is obtained from storage for use in authenticating the service request.

Note that the disclosed technology for using certificate permissions data for authentication utilizing service permissions bound to a digital certificate can be implemented in varying ways to suit a particular implementation or design without departing from the teachings of the disclosed technology.

FIG. 4I is a control flow diagram illustrating an example of a validation process 480 for blocks added to the certificate permissions data blockchain ledger 140 of FIG. 1 or ledger 200 of FIG. 2 implemented using untrusted blockchain nodes. In process 480, when a permissions data block 142 is created for certificate permissions blockchain 140, the transaction is broadcast, at 482, to the cluster of untrusted nodes. At 484, nodes compete to compute a validation solution for the transaction. At 486, a winning node broadcasts the validation solution for the permissions data block or access control rule block and adds the data block to its copy of the corresponding data blockchain ledger, e.g. certificate permissions blockchain 140 in FIG. 1.

At 488, in response to the winning node's broadcast, the other nodes add the permissions data block or access control rule block to their copy of the certificate permissions data blockchain ledger in the transaction order established by the winning node. The decentralized validation protocol can maintain the integrity, immutability and security of the permissions data blockchain ledger or certificate permissions data blockchain ledger.

It should be appreciated that the processes shown for examples and a variety of other approaches may be utilized without departing from the disclosed technology.

Depending upon the scripting capabilities of the blockchain platform, the methods or function in the data blocks of the permissions data blockchain may include more extensive code execution. For example, a permissions data system that provides for shared access to the permissions data by multiple users may involve more extensive code execution capability in the blockchain than a permissions data system that limits access to a single user, such as CA 110. Such a permissions data system may involve certificate permissions data being stored using permissions data blocks that include executable methods that control access to the permissions data or modification of the permissions data.

It should be appreciated that the utilization of authentication utilizing service permissions bound to a digital certificate with certificate permissions data can provide a high degree of flexibility, complexity and variation in the configuration of implementations without departing from the teaching of the disclosed technology.

FIG. 5 is a data architecture diagram showing an illustrative example of an interface for accessing permissions data in a certificate permissions blockchain on a blockchain platform, such as the permissions data blocks in FIGS. 1, 2 and 3B. In this example, an Application Program Interface (API) 510 provides an interface to the blockchain platform 520 that supports the certificate permissions blockchain. The blockchain platform 520 supports a smart contract 522, such as permissions data block 142 in FIG. 1, which includes a Get_perms( ) scripts 524 with code that, when executed by the blockchain platform 520, operates to obtain permissions data for a certificate that is stored on the certificate permissions blockchain.

### Blockchain Ledger Data Structure

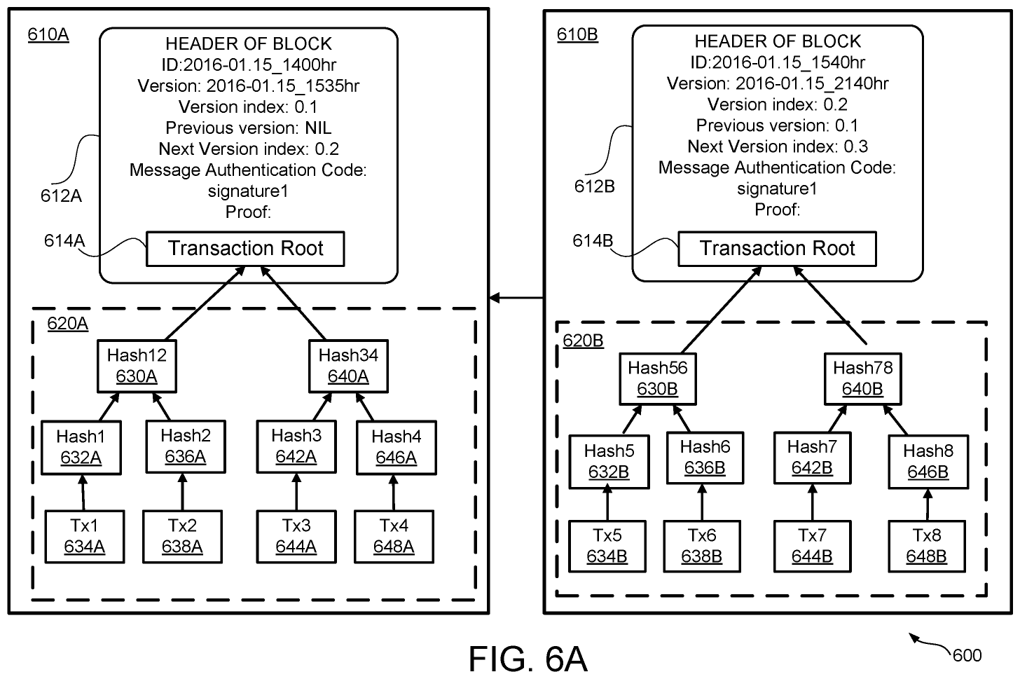

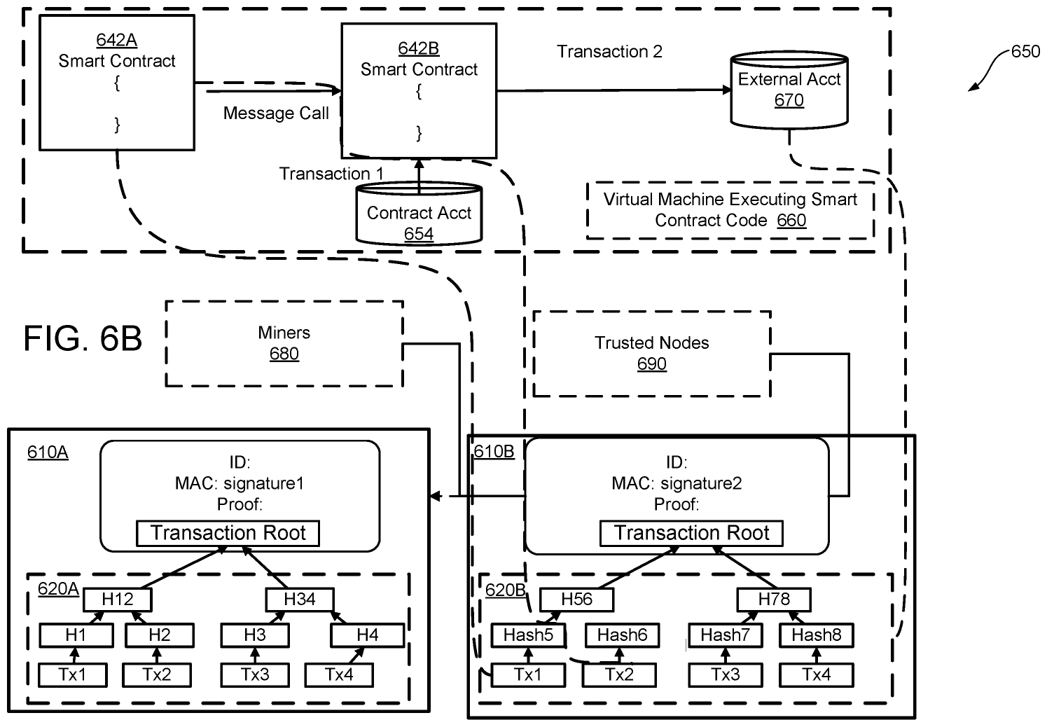

FIG. 6A is a data architecture diagram illustrating a simplified example of a blockchain ledger 600 based on the blocks 142A-E of the permissions data blockchain 140 of FIG. 1. The blockchain ledger 600 example of FIG. 6A is simplified to show block headers, metadata and signatures of blocks 142A-E in order to demonstrate a certificate permissions ledger using a blockchain. In outline, a blockchain ledger may be a globally shared transactional database.

FIG. 6A is an illustrative example of a blockchain ledger 600 with a data tree holding permission data that is verified using cryptographic techniques. In FIG. 6A, each block 610 includes a block header 612 with information regarding previous and subsequent blocks and stores a transaction root node 614 to a data tree 620 holding transactional data. Permission data may store smart contracts, data related to transactions, or any other data. The elements of smart contracts may also be stored within transaction nodes of the blocks.

In the example of FIG. 6A, a Merkle tree 620 is used to cryptographically secure the permission data. For example, Transaction Tx1 node 634A of data tree 620A of block 610A can be hashed to Hash1 node 632A, Transaction Tx2 node 638A may be hashed to Hash2 node 636A. Hash1 node 632A and Hash2 node 636A may be hashed to Hash12node 630A. A similar subtree may be formed to generate Hash34 node 640A. Hash12 node 630A and Hash34 node 640A may be hashed to Transaction Root 614A hash sorted in the data block 610A. By using a Merkle tree, or any similar data structure, the integrity of the transactions may be checked by verifying the hash is correct.

FIG. 6B is a data architecture diagram showing an illustrative example of smart contract code, transactions and messages that are bundled into a block so that their integrity is cryptographically secure and so that they may be appended to a blockchain ledger. In FIG. 6B, smart contracts 642 are code that executes on a computer. More specifically, the code of a smart contract may be stored in a blockchain ledger and executed by nodes of a distributed blockchain platform at a given time. The result of the smart code execution may be stored in a blockchain ledger. Optionally, a currency may be expended as smart contract code is executed. In the example of FIG. 6B, smart contracts 642 are executed in a virtual machine environment, although this is optional.

In FIG. 6B, the aspects of smart contracts 642 are stored in permission data nodes in data tree 620 in the blocks 610 of the blockchain ledger of FIG. 6A. In the example of FIG. 6B, Smart Contract 642A is stored in data block Tx1 node 634A of data tree 620A in block 610A, Smart Contract 642B is stored in Tx2 node 638A, Contract Account 654 associated with Smart Contract 642B is stored in Tx3 node 644A, and External Account is stored in Tx4 node 648A.

### Storage of Smart Contracts and Permission Data in the Blockchain Ledger

To ensure the smart contracts are secure and generate secure data, the blockchain ledger must be kept up to date. For example, if a smart contract is created, the code associated with a smart contract must be stored in a secure way. Similarly, when smart contract code executes and generates permission data, the permission data must be stored in a secure way.

In the example of FIG. 6B, two possible embodiments for maintenance of the blockchain ledger are shown. In one embodiment, untrusted miner nodes (“miners”) 680 may be rewarded for solving a cryptographic puzzle and thereby be allowed to append a block to the blockchain. Alternatively, a set of trusted nodes 690 may be used to append the next block to the blockchain ledger. Nodes may execute smart contract code, and then one winning node may append the next block to a blockchain ledger.

Though aspects of the technology disclosed herein resemble a smart contract, in the present techniques, the policy of the contract may determine the way that the blockchain ledger is maintained. For example, the policy may require that the validation or authorization process for blocks on the ledger is determined by a centralized control of a cluster of trusted nodes. In this case, the centralized control may be a trusted node, such as Certificate Authority 110, authorized to attest and sign the transaction blocks to validate them and validation by miners may not be needed.

Alternatively, the policy may provide for validation process decided by a decentralized cluster of untrusted nodes. In the situation where the blockchain ledger is distributed to a cluster of untrusted nodes, mining of blocks in the chain may be employed to validate the blockchain ledger.

Blockchains may use various time-stamping schemes, such as proof-of-work, to serialize changes. Alternate consensus methods include proof-of-stake, proof-of-burn, proof-of-research may also be utilized to serialize changes.

As noted above, in some examples, a blockchain ledger may be validated by miners to secure the blockchain. In this case, miners may collectively agree on a validation solution to be utilized. However, if a small network is utilized, e.g. private network, then the solution may be a Merkle tree and mining for the validation solution may not be required. When a transaction block is created, e.g. a permissions data block 142 for permissions data blockchain 140 or an access control rule block 152 for certificate permissions data blockchain 150, the block is an unconfirmed and unidentified entity. To be part of the acknowledged “currency”, it may be added to the blockchain, and therefore relates to the concept of a trusted cluster.

In a trusted cluster, when a data block 142 or 152 is added, every node competes to acknowledge the next “transaction” (e.g. a new permission data or access control rule block). In one example, the nodes compete to mine and get the lowest hash value: min{previous_hash, contents_hash, random_nonce_to_be_guessed}->result. Transaction order is protected by the computational race (faith that no one entity can beat the collective resources of the blockchain network). Mutual authentication parameters are broadcast and acknowledged to prevent double entries in the blockchain.

Alternatively, by broadcasting the meta-data for authenticating a secure ledger across a restricted network, e.g. only the signed hash is broadcast, the blockchain may reduce the risks that come with data being held centrally. Decentralized consensus makes blockchains suitable for the recording of secure transactions or events. The meta-data, which may contain information related to the data file, may also be ciphered for restricted access so that the meta-data does not disclose information pertaining to the data file.

The mining process, such as may be used in concert with the validation process 480 of FIG. 4I, may be utilized to deter double accounting, overriding or replaying attacks, with the community arrangement on the agreement based on the “good faith” that no single node can control the entire cluster. A working assumption for mining is the existence of equivalent power distribution of honest parties with supremacy over dishonest or compromised ones. Every node or miner in a decentralized system has a copy of the blockchain. No centralized “official” copy exists and no user is “trusted” more than any other. Transactions are broadcast, at 482, to the network using software. Mining nodes compete, at 484, to compute a validation solution to validate transactions, and then broadcast, at 486, the completed block validation to other nodes. Each node adds the block, at 488, to its copy of the blockchain with transaction order established by the winning node.

Note that in a restricted network, stake-holders who are authorized to check or mine for the data file may or may not access the transaction blocks themselves, but would need to have keys to the meta-data (since they are members of the restricted network, and are trusted) to get the details. As keys are applied on data with different data classifications, the stake-holders can be segmented.

A decentralized blockchain may also use ad-hoc secure message passing and distributed networking. In this example, the certificate permissions data blockchain ledger may be different from a conventional blockchain in that there is a centralized clearing house, e.g. authorized central control for validation. Without the mining process, the trusted cluster can be contained in a centralized blockchain instead of a public or democratic blockchain. One way to view this is that a decentralized portion is as “democratic N honest parties” (multiparty honest party is a cryptography concept), and a centralized portion as a “trusted monarchy for blockchain information correction”. For example, there may be advantages to maintaining the data file as centrally authorized and kept offline.

In some examples, access to a resource and access control rule on a blockchain can be restricted by cryptographic means to be only open to authorized servers. Since the permission data or certificate permissions data blockchain ledgers are distributed, the authorized servers can validate it. A public key may be used as an address on a public blockchain ledger.

Note that growth of a decentralized blockchain may be accompanied by the risk of node centralization because the computer resources required to operate on bigger data become increasingly expensive.

The present techniques may involve operations occurring in one or more machines. As used herein, “machine” means physical data-storage and processing hardware programed with instructions to perform specialized computing operations. It is to be understood that two or more different machines may share hardware components. For example, the same integrated circuit may be part of two or more different machines.

One of ordinary skill in the art will recognize that a wide variety of approaches may be utilized and combined with the present approach involving a certificate permissions data blockchain ledger. The specific examples of different aspects of a certificate permissions data blockchain ledger described herein are illustrative and are not intended to limit the scope of the techniques shown.

### Smart Contracts

Smart contracts are defined by code. As described previously, the terms and conditions of the smart contract may be encoded (e.g., by hash) into a blockchain ledger. Specifically, smart contracts may be compiled into a bytecode (if executed in a virtual machine), and then the bytecode may be stored in a blockchain ledger as described previously. Similarly, permission data executed and generated by smart contracts may be stored in the blockchain ledger in the ways previously described.

### Computer Architectures for Use of Smart Contracts and Blockchain Ledgers

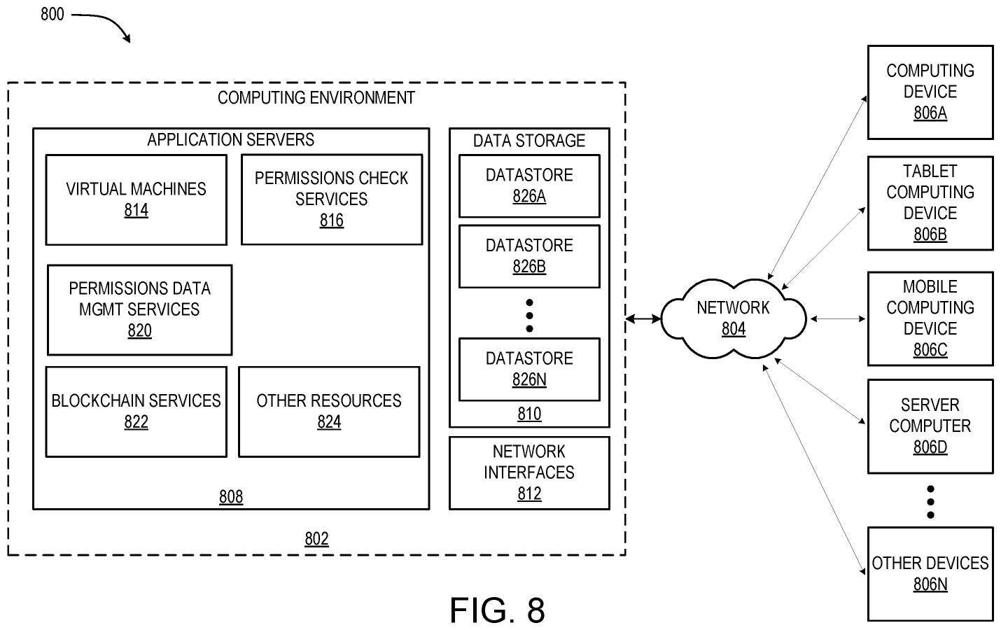

Note that at least parts of processes of FIGS. 4A-G, smart contract 522 of FIG. 5, smart contracts 642 of FIG. 6B, and other processes and operations pertaining to certificate permissions blockchain ledgers described herein may be implemented in one or more servers, such as computer environment 800 in FIG. 8, or the cloud, and data defining the results of user control input signals translated or interpreted as discussed herein may be communicated to a user device for display. Alternatively, the certificate permissions blockchain ledger processes may be implemented in a client device. In still other examples, some operations may be implemented in one set of computing resources, such as servers, and other steps may be implemented in other computing resources, such as a client device.

It should be understood that the methods described herein can be ended at any time and need not be performed in their entireties. Some or all operations of the methods described herein, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As described herein, in conjunction with the FIGURES described herein, the operations of the routines (e.g. processes of FIGS. 4A-G, smart contract 522 of FIG. 5, smart contracts 642 of FIG. 6B) are described herein as being implemented, at least in part, by an application, component, and/or circuit. Although the following illustration refers to the components of FIGS. 4A-G, 5 and 6B, it can be appreciated that the operations of the routines may be also implemented in many other ways. For example, the routines may be implemented, at least in part, by a computer processor or a processor or processors of another computer. In addition, one or more of the operations of the routines may alternatively or additionally be implemented, at least in part, by a computer working alone or in conjunction with other software modules.

For example, the operations of routines are described herein as being implemented, at least in part, by an application, component and/or circuit, which are generically referred to herein as modules. In some configurations, the modules can be a dynamically linked library (DLL), a statically linked library, functionality produced by an application programing interface (API), a compiled program, an interpreted program, a script or any other executable set of instructions. Data and/or modules, such as the data and modules disclosed herein, can be stored in a data structure in one or more memory components. Data can be retrieved from the data structure by addressing links or references to the data structure.

Although the following illustration refers to the components of the FIGURES discussed above, it can be appreciated that the operations of the routines (e.g. processes of FIGS. 4A-G, smart contract 522 of FIG. 5, smart contracts 642 of FIG. 6B) may be also implemented in many other ways. For example, the routines may be implemented, at least in part, by a processor of another remote computer or a local computer or circuit. In addition, one or more of the operations of the routines may alternatively or additionally be implemented, at least in part, by a chipset working alone or in conjunction with other software modules. Any service, circuit or application suitable for providing the techniques disclosed herein can be used in operations described herein.

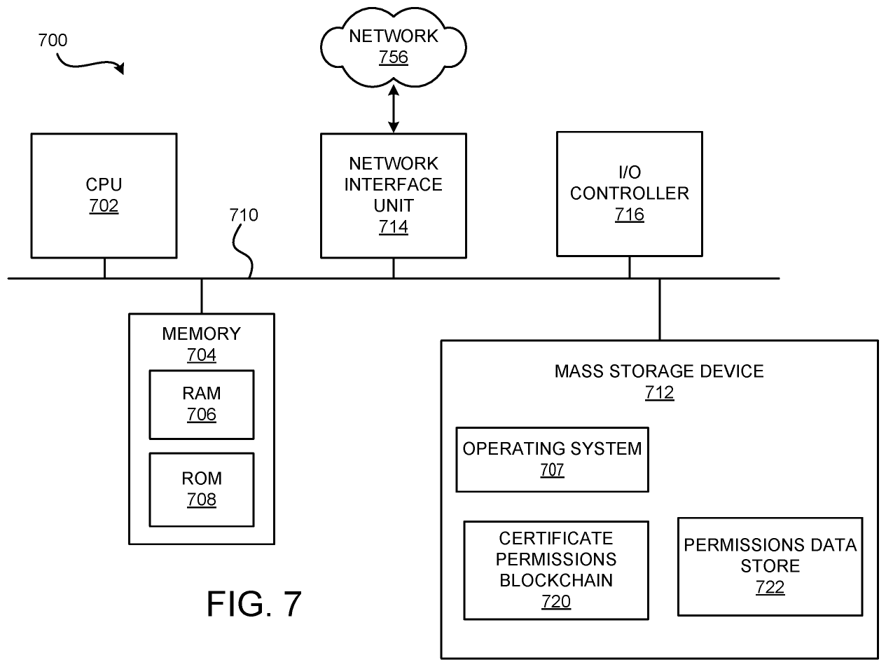

FIG. 7 shows additional details of an example computer architecture 700 for a computer, such as the devices 110 and 120A-C (FIG. 1), capable of executing the program components described herein. Thus, the computer architecture 700 illustrated in FIG. 7 illustrates an architecture for a server computer, mobile phone, a PDA, a smart phone, a desktop computer, a netbook computer, a tablet computer, an on-board computer, a game console, and/or a laptop computer. The computer architecture 700 may be utilized to execute any aspects of the software components presented herein.

The computer architecture 700 illustrated in FIG. 7 includes a central processing unit 702 (“CPU”), a system memory 704, including a random access memory 706 (“RAM”) and a read-only memory (“ROM”) 708, and a system bus 710 that couples the memory 704 to the CPU 702. A basic input/output system containing the basic routines that help to transfer information between sub-elements within the computer architecture 700, such as during startup, is stored in the ROM 708. The computer architecture 700 further includes a mass storage device 712 for storing an operating system 707, data (such as a copy of certificate permissions blockchain data 720 or permissions data store 722), and one or more application programs.

The mass storage device 712 is connected to the CPU 702 through a mass storage controller (not shown) connected to the bus 710. The mass storage device 712 and its associated computer-readable media provide non-volatile storage for the computer architecture 700. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture 700.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 700. For purposes the claims, the phrase “computer storage medium,” “computer-readable storage medium” and variations thereof, does not include waves, signals, and/or other transitory and/or intangible communication media, per se.

According to various configurations, the computer architecture 700 may operate in a networked environment using logical connections to remote computers through the network 756 and/or another network (not shown). The computer architecture 700 may connect to the network 756 through a network interface unit 714 connected to the bus 710. It should be appreciated that the network interface unit 714 also may be utilized to connect to other types of networks and remote computer systems. The computer architecture 700 also may include an input/output controller 716 for receiving and processing input from a number of other devices, including a keyboard, mouse, game controller, television remote or electronic stylus (not shown in FIG. 7). Similarly, the input/output controller 716 may provide output to a display screen, a printer, or other type of output device (also not shown in FIG. 7).

It should be appreciated that the software components described herein may, when loaded into the CPU 702 and executed, transform the CPU 702 and the overall computer architecture 700 from a general-purpose computing system into a special-purpose computing system customized to facilitate the functionality presented herein. The CPU 702 may be constructed from any number of transistors or other discrete circuit elements, which may individually or collectively assume any number of states. More specifically, the CPU 702 may operate as a finite-state machine, in response to executable instructions contained within the software modules disclosed herein. These computer-executable instructions may transform the CPU 702 by specifying how the CPU 702 transitions between states, thereby transforming the transistors or other discrete hardware elements constituting the CPU 702.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 700 in order to store and execute the software components presented herein. It also should be appreciated that the computer architecture 700 may include other types of computing devices, including hand-held computers, embedded computer systems, personal digital assistants, and other types of computing devices known to those skilled in the art. It is also contemplated that the computer architecture 700 may not include all of the components shown in FIG. 7, may include other components that are not explicitly shown in FIG. 7, or may utilize an architecture completely different than that shown in FIG. 7.

FIG. 8 depicts an illustrative distributed computing environment 800 capable of executing the software components described herein for system level authentication utilizing service permissions bound to a digital certificate for a blockchain ledger. Thus, the distributed computing environment 800 illustrated in FIG. 8 can be utilized to execute many aspects of the software components presented herein. For example, the distributed computing environment 800 can be utilized to execute one or more aspects of the software components described herein. Also, the distributed computing environment 800 may represent components of the distributed blockchain platform discussed above.

According to various implementations, the distributed computing environment 800 includes a computing environment 802 operating on, in communication with, or as part of the network 804. The network 804 may be or may include the network 856, described above. The network 804 also can include various access networks. One or more client devices 806A-806N (hereinafter referred to collectively and/or generically as “clients 806”) can communicate with the computing environment 802 via the network 804 and/or other connections (not illustrated in FIG. 8). In one illustrated configuration, the clients 806 include a computing device 806A, such as a laptop computer, a desktop computer, or other computing device; a slate or tablet computing device (“tablet computing device”) 806B; a mobile computing device 806C such as a mobile telephone, a smart phone, an on-board computer, or other mobile computing device; a server computer 806D; and/or other devices 806N, which can include a hardware security module. It should be understood that any number of devices 806 can communicate with the computing environment 802. Two example computing architectures for the devices 806 are illustrated and described herein with reference to FIGS. 7 and 8. It should be understood that the illustrated devices 806 and computing architectures illustrated and described herein are illustrative only and should not be construed as being limited in any way.

In the illustrated configuration, the computing environment 802 includes application servers 808, data storage 810, and one or more network interfaces 812. According to various implementations, the functionality of the application servers 808 can be provided by one or more server computers that are executing as part of, or in communication with, the network 804. The application servers 808 can host various services, virtual machines, portals, and/or other resources. In the illustrated configuration, the application servers 808 host one or more virtual machines 814 for hosting applications or other functionality. According to various implementations, the virtual machines 814 host one or more applications and/or software modules for a data management blockchain ledger. It should be understood that this configuration is illustrative only and should not be construed as being limiting in any way.

The application servers 808 can also host authentication utilizing service permissions bound to a digital certificate in permissions check services module 816, such as those described with respect to client/servers 320B of FIG. 3A, client/server 340B of FIG. 3C or client/server 360B of FIG. 3E. Permissions check services module 816 can apply permissions data for a certificate to requests from entities executing in virtual machines 814.

According to various implementations, the application servers 808 also include one or more permission data management services 820 and one or more blockchain services 822. The permission data management services 820 can include services for managing permission data on a certificate permissions blockchain, such as certificate permissions blockchain 140 in FIG. 1. The blockchain services 822 can include services for participating in management of one or more blockchains, such as by creating genesis blocks or permissions data blocks, and performing validation.

As shown in FIG. 8, the application servers 808 also can host other services, applications, portals, and/or other resources (“other resources”) 824. The other resources 824 can include, but are not limited to, data encryption, data sharing, or any other functionality.

As mentioned above, the computing environment 802 can include data storage 810. According to various implementations, the functionality of the data storage 810 is provided by one or more databases or data stores operating on, or in communication with, the network 804. The functionality of the data storage 810 also can be provided by one or more server computers configured to host data for the computing environment 802. The data storage 810 can include, host, or provide one or more real or virtual data stores 826A-826N (hereinafter referred to collectively and/or generically as “datastores 826”). The datastores 826 are configured to host data used or created by the application servers 808 and/or other data. Aspects of the datastores 826 may be associated with services for a certificate permissions data blockchain. Although not illustrated in FIG. 8, the datastores 826 also can host or store web page documents, word documents, presentation documents, data structures, algorithms for execution by a recommendation engine, and/or other data utilized by any application program or another module.

The computing environment 802 can communicate with, or be accessed by, the network interfaces 812. The network interfaces 812 can include various types of network hardware and software for supporting communications between two or more computing devices including, but not limited to, the clients 806 and the application servers 808. It should be appreciated that the network interfaces 812 also may be utilized to connect to other types of networks and/or computer systems.

It should be understood that the distributed computing environment 800 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 800 may provide the software functionality described herein as a service to the clients using devices 806. It should be understood that the devices 806 can include real or virtual machines including, but not limited to, server computers, web servers, personal computers, mobile computing devices, smart phones, and/or other devices, which can include user input devices. As such, various configurations of the concepts and technologies disclosed herein enable any device configured to access the distributed computing environment 800 to utilize the functionality described herein for creating and supporting a certificate permissions data blockchain ledger, among other aspects.

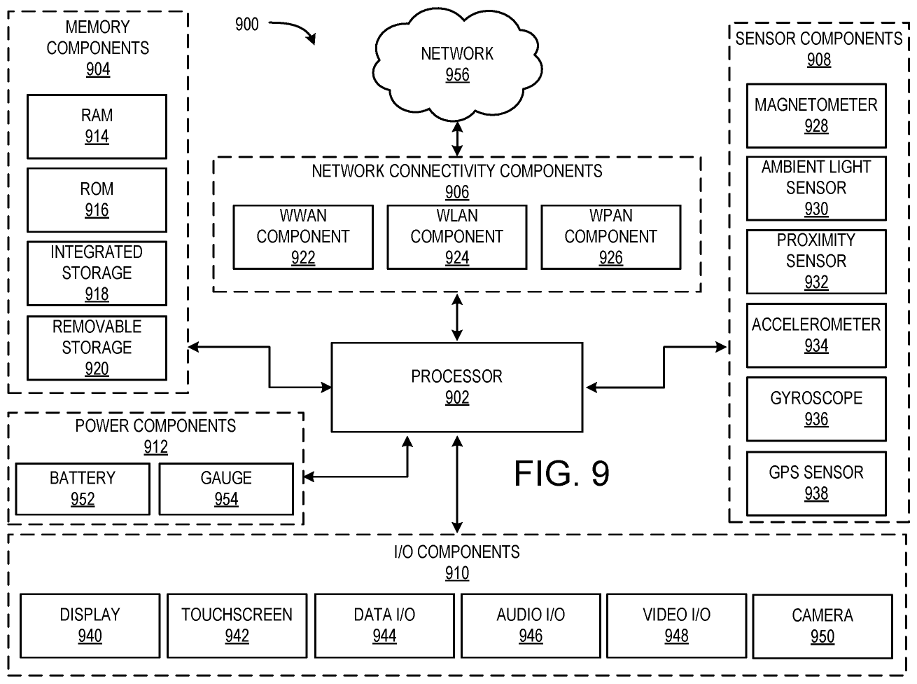

Turning now to FIG. 9, an illustrative computing device architecture 900 for a computing device that is capable of executing various software components is described herein for supporting a blockchain ledger and applying certificate permissions data to the blockchain ledger. The computing device architecture 900 is applicable to computing devices that can manage a blockchain ledger. In some configurations, the computing devices include, but are not limited to, mobile telephones, on-board computers, tablet devices, slate devices, portable video game devices, traditional desktop computers, portable computers (e.g., laptops, notebooks, ultra-portables, and netbooks), server computers, game consoles, and other computer systems. The computing device architecture 900 is applicable to the Certificate Authority 110, client/servers 120A-C and blockchain platform 130 shown in FIG. 1 and computing device 806A-N shown in FIG. 8.

The computing device architecture 900 illustrated in FIG. 9 includes a processor 902, memory components 904, network connectivity components 906, sensor components 908, input/output components 910, and power components 912. In the illustrated configuration, the processor 902 is in communication with the memory components 904, the network connectivity components 906, the sensor components 908, the input/output (“I/O”) components 910, and the power components 912. Although no connections are shown between the individual components illustrated in FIG. 9, the components can interact to carry out device functions. In some configurations, the components are arranged so as to communicate via one or more busses (not shown).

The processor 902 includes a central processing unit (“CPU”) configured to process data, execute computer-executable instructions of one or more application programs, and communicate with other components of the computing device architecture 900 in order to perform various functionality described herein. The processor 902 may be utilized to execute aspects of the software components presented herein and, particularly, those that utilize, at least in part, secure data.

In some configurations, the processor 902 includes a graphics processing unit (“GPU”) configured to accelerate operations performed by the CPU, including, but not limited to, operations performed by executing secure computing applications, general-purpose scientific and/or engineering computing applications, as well as graphics-intensive computing applications such as high resolution video (e.g., 620P, 1080P, and higher resolution), video games, three-dimensional (“3D”) modeling applications, and the like. In some configurations, the processor 902 is configured to communicate with a discrete GPU (not shown). In any case, the CPU and GPU may be configured in accordance with a co-processing CPU/GPU computing model, wherein a sequential part of an application executes on the CPU and a computationally-intensive part is accelerated by the GPU.

In some configurations, the processor 902 is, or is included in, a system-on-chip (“SoC”) along with one or more of the other components described herein below. For example, the SoC may include the processor 902, a GPU, one or more of the network connectivity components 906, and one or more of the sensor components 908. In some configurations, the processor 902 is fabricated, in part, utilizing a package-on-package (“PoP”) integrated circuit packaging technique. The processor 902 may be a single core or multi-core processor.

The processor 902 may be created in accordance with an ARM architecture, available for license from ARM HOLDINGS of Cambridge, United Kingdom. Alternatively, the processor 902 may be created in accordance with an x86 architecture, such as is available from INTEL CORPORATION of Mountain View, Calif. and others. In some configurations, the processor 902 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 904 include a random access memory (“RAM”) 914, a read-only memory (“ROM”) 916, an integrated storage memory (“integrated storage”) 918, and a removable storage memory (“removable storage”) 920. In some configurations, the RAM 914 or a portion thereof, the ROM 916 or a portion thereof, and/or some combination of the RAM 914 and the ROM 916 is integrated in the processor 902. In some configurations, the ROM 916 is configured to store a firmware, an operating system or a portion thereof (e.g., operating system kernel), and/or a bootloader to load an operating system kernel from the integrated storage 918 and/or the removable storage 920.

The integrated storage 918 can include a solid-state memory, a hard disk, or a combination of solid-state memory and a hard disk. The integrated storage 918 may be soldered or otherwise connected to a logic board upon which the processor 902 and other components described herein also may be connected. As such, the integrated storage 918 is integrated in the computing device. The integrated storage 918 is configured to store an operating system or portions thereof, application programs, data, and other software components described herein.

The removable storage 920 can include a solid-state memory, a hard disk, or a combination of solid-state memory and a hard disk. In some configurations, the removable storage 920 is provided in lieu of the integrated storage 918. In other configurations, the removable storage 920 is provided as additional optional storage. In some configurations, the removable storage 920 is logically combined with the integrated storage 918 such that the total available storage is made available as a total combined storage capacity. In some configurations, the total combined capacity of the integrated storage 918 and the removable storage 920 is shown to a user instead of separate storage capacities for the integrated storage 918 and the removable storage 920.

The removable storage 920 is configured to be inserted into a removable storage memory slot (not shown) or other mechanism by which the removable storage 920 is inserted and secured to facilitate a connection over which the removable storage 920 can communicate with other components of the computing device, such as the processor 902. The removable storage 920 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 904 can store an operating system. According to various configurations, the operating system may include, but is not limited to, server operating systems such as various forms of UNIX certified by The Open Group and LINUX certified by the Free Software Foundation, or aspects of Software-as-a-Service (SaaS) architectures, such as MICROSFT AZURE from Microsoft Corporation of Redmond, Wash. or AWS from Amazon Corporation of Seattle, Wash. The operating system may also include WINDOWS MOBILE OS from Microsoft Corporation of Redmond, Wash., WINDOWS PHONE OS from Microsoft Corporation, WINDOWS from Microsoft Corporation, MAC OS or IOS from Apple Inc. of Cupertino, Calif., and ANDROID OS from Google Inc. of Mountain View, Calif. Other operating systems are contemplated.

The network connectivity components 906 include a wireless wide area network component (“WWAN component”) 922, a wireless local area network component (“WLAN component”) 924, and a wireless personal area network component (“WPAN component”) 926. The network connectivity components 906 facilitate communications to and from the network 956 or another network, which may be a WWAN, a WLAN, or a WPAN. Although only the network 956 is illustrated, the network connectivity components 906 may facilitate simultaneous communication with multiple networks, including the network 956 of FIG. 9. For example, the network connectivity components 906 may facilitate simultaneous communications with multiple networks via one or more of a WWAN, a WLAN, or a WPAN.

The network 956 may be or may include a WWAN, such as a mobile telecommunications network utilizing one or more mobile telecommunications technologies to provide voice and/or data services to a computing device utilizing the computing device architecture 900 via the WWAN component 922. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 956 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 956 may be configured to provide voice and/or data communications with any combination of the above technologies. The network 956 may be configured to or be adapted to provide voice and/or data communications in accordance with future generation technologies.

In some configurations, the WWAN component 922 is configured to provide dual- multi-mode connectivity to the network 956. For example, the WWAN component 922 may be configured to provide connectivity to the network 956, wherein the network 956 provides service via GSM and UMTS technologies, or via some other combination of technologies. Alternatively, multiple WWAN components 922 may be utilized to perform such functionality, and/or provide additional functionality to support other non-compatible technologies (i.e., incapable of being supported by a single WWAN component). The WWAN component 922 may facilitate similar connectivity to multiple networks (e.g., a UMTS network and an LTE network).

The network 956 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 924 is configured to connect to the network 956 via the WI-FI access points. Such connections may be secured via various encryption technologies including, but not limited to, WI-FI Protected Access (“WPA”), WPA2, Wired Equivalent Privacy (“WEP”), and the like.

The network 956 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 926 is configured to facilitate communications with other devices, such as peripherals, computers, or other computing devices via the WPAN.

The sensor components 908 include a magnetometer 928, an ambient light sensor 930, a proximity sensor 932, an accelerometer 934, a gyroscope 936, and a Global Positioning System sensor (“GPS sensor”) 938. It is contemplated that other sensors, such as, but not limited to, temperature sensors or shock detection sensors, also may be incorporated in the computing device architecture 900.

The I/O components 910 include a display 940, a touchscreen 942, a data I/O interface component (“data I/O”) 944, an audio I/O interface component (“audio I/O”) 946, a video I/O interface component (“video I/O”) 948, and a camera 950. In some configurations, the display 940 and the touchscreen 942 are combined. In some configurations two or more of the data I/O component 944, the audio I/O component 946, and the video I/O component 948 are combined. The I/O components 910 may include discrete processors configured to support the various interfaces described below or may include processing functionality built-in to the processor 902.

The illustrated power components 912 include one or more batteries 952, which can be connected to a battery gauge 954. The batteries 952 may be rechargeable or disposable. Rechargeable battery types include, but are not limited to, lithium polymer, lithium ion, nickel cadmium, and nickel metal hydride. Each of the batteries 952 may be made of one or more cells.

The power components 912 may also include a power connector, which may be combined with one or more of the aforementioned I/O components 910. The power components 912 may interface with an external power system or charging equipment via an I/O component.

### Examples of Various Implementations

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The present disclosure is made in light of the following clauses:

[symbol]

Clause 1: A computer-implemented method for authenticating service requests on a communication link, the method comprising: receiving a service request from an entity through a communication link established using a digital certificate owned by the entity, where permissions data is associated with the digital certificate; responsive to the service request, obtaining the permissions data associated with the digital certificate; checking the service request against the permissions data associated with the digital certificate; if the service request is permitted based on the permissions data, processing the service request; and if the service request is not permitted based on the permissions data, rejecting the service request.

Clause 2. The computer-implemented method of Clause 1, where: the digital certificate includes a blockchain address to a certificate permissions blockchain that stores the permissions data; and the step of obtaining the permissions data associated with the digital certificate comprises obtaining the permissions data from the certificate permissions blockchain using the blockchain address from the digital certificate.

Clause 3. The computer-implemented method of Clause 2, where the method includes: receiving modified permissions data for the digital certificate; creating a new permissions data block that stores the modified permissions data; and linking the new permissions data block to a previous permissions data block of the certificate permissions blockchain.

Clause 4. The computer-implemented method of Clause 1, where: the permissions data for the digital certificate is stored on a certificate authority for the digital certificate; and the step of obtaining the permissions data associated with the digital certificate comprises obtaining the permissions data from the certificate authority for the digital certificate.

Clause 5. The computer-implemented method of Clause 4, where the method includes: receiving modified permissions data for the digital certificate; and storing the modified permissions data for the digital certificate on the certificate authority for the digital certificate.

Clause 6. The computer-implemented method of Clause 1, where: the digital certificate includes the permissions data; and the method includes storing the permissions data for the digital certificate in a local store; and the step of obtaining the permissions data associated with the digital certificate comprises obtaining the permissions data from the local store.

Clause 7. The computer-implemented method of Clause 1, where: the step of obtaining the permissions data associated with the digital certificate comprises obtaining the permissions data associated with the digital certificate when authenticating the communication link established using the digital certificate owned by the entity.

Clause 8. A system for authenticating service requests on a communication link, the system comprising: one or more processors; and one or more memory devices in communication with the one or more processors, the memory devices having computer-readable instructions stored thereupon that, when executed by the processors, cause the processors to perform a method for authenticating service requests on a communication link, the method comprising: receiving a service request from an entity through a communication link established using a digital certificate owned by the entity, where permissions data is associated with the digital certificate; responsive to the service request, obtaining the permissions data associated with the digital certificate; checking the service request against the permissions data associated with the digital certificate; if the service request is permitted based on the permissions data, processing the service request; and if the service request is not permitted based on the permissions data, rejecting the service request.

Clause 9. The system of Clause 8, where: the digital certificate includes a blockchain address to a certificate permissions blockchain that stores the permissions data; and the step of obtaining the permissions data associated with the digital certificate comprises obtaining the permissions data from the certificate permissions blockchain using the blockchain address from the digital certificate.

Clause 10. The system of Clause 9, where the method includes: receiving modified permissions data for the digital certificate; creating a new permissions data block that stores the modified permissions data; and linking the new permissions data block to a previous permissions data block of the certificate permissions blockchain.

Clause 11. The system of Clause 8, where: the permissions data for the digital certificate is stored on a certificate authority for the digital certificate; and the step of obtaining the permissions data associated with the digital certificate comprises obtaining the permissions data from the certificate authority for the digital certificate.

Clause 12. The system of Clause 11, where the method includes: receiving modified permissions data for the digital certificate; and storing the modified permissions data for the digital certificate on the certificate authority for the digital certificate.

Clause 13. The system of Clause 8, where: the digital certificate includes the permissions data; and the method includes storing the permissions data for the digital certificate in a local store; and the step of obtaining the permissions data associated with the digital certificate comprises obtaining the permissions data from the local store.

Clause 14. The system of Clause 8, where: the step of obtaining the permissions data associated with the digital certificate comprises obtaining the permissions data associated with the digital certificate when the service request is received on the communication link established using the digital certificate owned by the entity.

Clause 15. One or more computer storage media having computer executable instructions stored thereon which, when executed by one or more processors, cause the processors to execute a method for authenticating service requests on a communication link, the method comprising: receiving a service request from an entity through a communication link established using a digital certificate owned by the entity, where permissions data is associated with the digital certificate; responsive to the service request, obtaining the permissions data associated with the digital certificate; checking the service request against the permissions data associated with the digital certificate; if the service request is permitted based on the permissions data, processing the service request; and if the service request is not permitted based on the permissions data, rejecting the service request.

Clause 16. The computer storage media of Clause 15, where: the digital certificate includes a blockchain address to a certificate permissions blockchain that stores the permissions data; and the step of obtaining the permissions data associated with the digital certificate comprises obtaining the permissions data from the certificate permissions blockchain using the blockchain address from the digital certificate.

Clause 17. The computer storage media of Clause 16, where the method includes: receiving modified permissions data for the digital certificate; creating a new permissions data block that stores the modified permissions data; and linking the new permissions data block to a previous permissions data block of the certificate permissions blockchain.

Clause 18. The computer storage media of Clause 15, where: the permissions data for the digital certificate is stored on a certificate authority for the digital certificate; and the step of obtaining the permissions data associated with the digital certificate comprises obtaining the permissions data from the certificate authority for the digital certificate.

Clause 19. The computer storage media of Clause 18, where the method includes: receiving modified permissions data for the digital certificate; and storing the modified permissions data for the digital certificate on the certificate authority for the digital certificate.

Clause 20. The computer storage media of Clause 15, where: the digital certificate includes the permissions data; and the method includes storing the permissions data for the digital certificate in a local store; and the step of obtaining the permissions data associated with the digital certificate comprises obtaining the permissions data from the local store.

Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method for authenticating service requests on a communication link, the method comprising:
receiving a service request from an entity through a communication link established using a digital certificate owned by the entity, where permissions data is associated with the digital certificate;
responsive to the service request, obtaining the permissions data associated with the digital certificate;
checking the service request against the permissions data associated with the digital certificate;
if the service request is permitted based on the permissions data, processing the service request; and
if the service request is not permitted based on the permissions data, rejecting the service request.

2. The computer-implemented method of claim 1, where:
the digital certificate includes a blockchain address to a certificate permissions blockchain that stores the permissions data; and
the step of obtaining the permissions data associated with the digital certificate comprises obtaining the permissions data from the certificate permissions blockchain using the blockchain address from the digital certificate.

3. The computer-implemented method of claim 2, where the method includes:
receiving modified permissions data for the digital certificate;
creating a new permissions data block that stores the modified permissions data; and
linking the new permissions data block to a previous permissions data block of the certificate permissions blockchain.

4. The computer-implemented method of claim 1, where:
the permissions data for the digital certificate is stored on a certificate authority for the digital certificate; and
the step of obtaining the permissions data associated with the digital certificate comprises obtaining the permissions data from the certificate authority for the digital certificate.

5. The computer-implemented method of claim 4, where the method includes:
receiving modified permissions data for the digital certificate; and
storing the modified permissions data for the digital certificate on the certificate authority for the digital certificate.

6. The computer-implemented method of claim 1, where:
the digital certificate includes the permissions data; and
the method includes storing the permissions data for the digital certificate in a local store; and
the step of obtaining the permissions data associated with the digital certificate comprises obtaining the permissions data from the local store.

7. The computer-implemented method of claim 1, where:
the step of obtaining the permissions data associated with the digital certificate comprises obtaining the permissions data associated with the digital certificate when authenticating the communication link established using the digital certificate owned by the entity.

8. A system for authenticating service requests on a communication link, the system comprising:
one or more processors; and
one or more memory devices in communication with the one or more processors, the memory devices having computer-readable instructions stored thereupon that, when executed by the processors, cause the processors to perform a method for authenticating service requests on a communication link, the method comprising:
receiving a service request from an entity through a communication link established using a digital certificate owned by the entity, where permissions data is associated with the digital certificate;
responsive to the service request, obtaining the permissions data associated with the digital certificate;
checking the service request against the permissions data associated with the digital certificate;
if the service request is permitted based on the permissions data, processing the service request; and
if the service request is not permitted based on the permissions data, rejecting the service request.

9. The system of claim 8, where:
the digital certificate includes a blockchain address to a certificate permissions blockchain that stores the permissions data; and
the step of obtaining the permissions data associated with the digital certificate comprises obtaining the permissions data from the certificate permissions blockchain using the blockchain address from the digital certificate.

10. The system of claim 9, where the method includes:
receiving modified permissions data for the digital certificate;
creating a new permissions data block that stores the modified permissions data; and
linking the new permissions data block to a previous permissions data block of the certificate permissions blockchain.

11. The system of claim 8, where:
the permissions data for the digital certificate is stored on a certificate authority for the digital certificate; and
the step of obtaining the permissions data associated with the digital certificate comprises obtaining the permissions data from the certificate authority for the digital certificate.

12. The system of claim 11, where the method includes:
receiving modified permissions data for the digital certificate; and
storing the modified permissions data for the digital certificate on the certificate authority for the digital certificate.

13. The system of claim 8, where:
the digital certificate includes the permissions data; and
the method includes storing the permissions data for the digital certificate in a local store; and
the step of obtaining the permissions data associated with the digital certificate comprises obtaining the permissions data from the local store.

14. The system of claim 8, where:
the step of obtaining the permissions data associated with the digital certificate comprises obtaining the permissions data associated with the digital certificate when the service request is received on the communication link established using the digital certificate owned by the entity.

15. One or more computer storage media having computer executable instructions stored thereon which, when executed by one or more processors, cause the processors to execute a method for authenticating service requests on a communication link, the method comprising:
receiving a service request from an entity through a communication link established using a digital certificate owned by the entity, where permissions data is associated with the digital certificate;
responsive to the service request, obtaining the permissions data associated with the digital certificate;
checking the service request against the permissions data associated with the digital certificate;
if the service request is permitted based on the permissions data, processing the service request; and
if the service request is not permitted based on the permissions data, rejecting the service request.

16. The computer storage media of claim 15, where:
the digital certificate includes a blockchain address to a certificate permissions blockchain that stores the permissions data; and
the step of obtaining the permissions data associated with the digital certificate comprises obtaining the permissions data from the certificate permissions blockchain using the blockchain address from the digital certificate.

17. The computer storage media of claim 16, where the method includes:
receiving modified permissions data for the digital certificate;
creating a new permissions data block that stores the modified permissions data; and
linking the new permissions data block to a previous permissions data block of the certificate permissions blockchain.

18. The computer storage media of claim 15, where:
the permissions data for the digital certificate is stored on a certificate authority for the digital certificate; and
the step of obtaining the permissions data associated with the digital certificate comprises obtaining the permissions data from the certificate authority for the digital certificate.

19. The computer storage media of claim 18, where the method includes:
receiving modified permissions data for the digital certificate; and
storing the modified permissions data for the digital certificate on the certificate authority for the digital certificate.

20. The computer storage media of claim 15, where:
the digital certificate includes the permissions data; and
the method includes storing the permissions data for the digital certificate in a local store; and
the step of obtaining the permissions data associated with the digital certificate comprises obtaining the permissions data from the local store.
